(19) United States
(12) Patent Application Publication
(10) Pub. No.: US 2002/0103889 A1
(43) Pub. Date: Aug. 1, 2002

(54) Virtual storage layer approach for dynamically associating computer storage with processing hosts

(76) Inventors: Thomas Markson, San Mateo, CA (US); Ashar Aziz, Fremont, CA (US); Martin Patterson, Mountain View, CA (US); Benjamin H. Stoltz, Mountain View, CA (US); Osman Ismael, Sunnyvale, CA (US); Jayaraman Manni, Santa Clara, CA (US); Suvendu Ray, Santa Clara, CA (US); Chris La, Union City, CA (US)

Correspondence Address: Hickman Palermo Truong & Becker, 600 Willow Street, San Jose, CA, 95125-5106, US

(21) Appl. No.: 09/885,290

(22) Filed: Jun. 19, 2001

Related U.S. Application Data
(63) Continuation-in-part of application No. 09/502,170, filed on Feb. 11, 2000.
(60) Provisional application No. 60/212,936, filed on Jun. 20, 2000.
(60) Provisional application No. 60/212,873, filed on Jun. 20, 2000.

(51) Int. Cl. G06F 15/173

(52) U.S. Cl. 709/223

(57) ABSTRACT

A method and apparatus for selectively logically adding storage to a host features dynamically mapping one or more disk volumes to the host using a storage virtualization layer, without affecting an operating system of the host or its configuration. Storage devices participate in storage area networks and are coupled to gateways. A boot port of the host is coupled to a direct-attached storage network that includes a switching fabric. When a host needs storage to participate in a virtual server farm, software elements allocate one or more volumes or concatenated volumes of disk storage, and command the gateways and switches in the storage networks to logically and physically connect the host to the allocated volumes. As a result, the host acquires access to storage without modification to a configuration of the host, and a real-world virtual server farm or data center may be created and deployed substantially instantly.

### CROSS-REFERENCE TO RELATED APPLICATIONS

Continuation-in-part of application Ser. No. 09/502,170, filed Feb. 11, 2000, entitled “Extensible Computing System,” naming Ashar Aziz et al. as inventors. Domestic priority under 35 U.S.C. §120 is claimed therefrom. This application is related to application Ser. No. 09/630,440, filed Sep. 20, 2000, Method And Apparatus for Controlling an Extensible Computing System, of Ashar Aziz et al. Domestic priority is claimed under 35 U.S.C. § 119 from prior Provisional application Ser. No. 60/212,936, filed Jun. 20, 2000, entitled “Computing Grid Architecture,” and naming as inventors Ashar Aziz, Martin Patterson, Thomas Markson, and from prior Provisional application Ser. No. 60/212,873, filed Jun. 20, 2000, entitled “Storage Architecture and Implementation,” and naming as inventors Ashar Aziz, Martin Patterson, Thomas Markson.

### FIELD OF THE INVENTION

The present invention generally relates to data processing. The invention relates more specifically to a virtual storage layer approach for dynamically associating computer storage with processing hosts.

### BACKGROUND OF THE INVENTION

Data processing users desire to have a flexible, extensible way to rapidly create and deploy complex computer systems and data centers that include a plurality of servers, one or more load balancers, firewalls, and other network elements. One method for creating such a system is described in co-pending application Ser. No. 09/502,170, filed Feb. 11, 2000, entitled “Extensible Computing System,” naming Ashar Aziz et al. as inventors, the entire disclosure of which is hereby incorporated by reference as if fully set forth herein. Aziz et al. disclose a method and apparatus for selecting, from within a large, extensible computing framework, elements for configuring a particular computer system. Accordingly, upon demand, a virtual server farm or other data center may be created, configured and brought on-line to carry out useful work, all over a global computer network, virtually instantaneously.

Although the methods and systems disclosed in Aziz et al. are powerful and flexible, users and administrators of the extensible computing framework, and the virtual server farms that are created using it, would benefit from improved methods for associating storage devices to processors in virtual server farms. For example, an improvement upon Aziz et al. would be a way to dynamically associate a particular amount of computer data storage with a particular processor for a particular period of time, and to disassociate the storage from that processor when the storage is no longer needed.

Using one known online service, “Rackspace.com,” a user may select a server platform, configure it with a desired combination of disk storage, tape backup, and certain software options, and then purchase use of the configured server on a monthly basis. However, this service is useful only for configuring a single server computer. Further, the system does not provide a way to dynamically or automatically add and remove desired amounts of storage from the server.

A characteristic of the approaches for instantiating, using, and releasing virtual server farms disclosed in Ashar et al. is that a particular storage device may be used, at one particular time, for the benefit of a first enterprise, and later used for the benefit of an entirely different second enterprise. Thus, one storage device may potentially be used to successively store private, confidential data of two unrelated enterprises. Therefore, strong security is required to ensure that when a storage device is re-assigned to a virtual server farm of a different enterprise, there is no way for that enterprise to use or access data recorded on the storage device by the previous enterprise. Prior approaches fail to address this critical security issue.

A related problem is that each enterprise is normally given root password access to its virtual server farm, so that the enterprise can monitor the virtual server farm, load data on it, etc. Moreover, the owner or operator of a data center that contains one or more virtual server farms does not generally monitor the activities of enterprise users on their assigned servers. Such users may use whatever software they wish on their servers, and are not required to notify the owner or operator of the data center when changes are made to the server. The virtual server farms are comprised of processing hosts that are considered un-trusted, yet they must use storage that is fully secure.

Accordingly, there is need to ensure that such an enterprise cannot access the storage devices and obtain access to a storage device that is not part of its virtual server farm.

Still another problem is that to improve security, the storage devices that are selectively associated with processors in virtual server farms should be located in a centralized point. It is desirable to have a single management point, and to preclude the use of disk storage that is physically local to a processor that is implementing a virtual server farm, in order to prevent unauthorized tampering with such storage by an enterprise user.

Yet another problem is that enterprise users of virtual server farms wish to have complete control over the operating system and application programs that execute for the benefit of an enterprise in the virtual server farm. In past approaches, adding storage to a processing host has required modification of operating system configuration files, followed by re-booting the host so that its operating system becomes aware of the changed storage configuration. However, enterprise users wish to define a particular disk image, consisting of an operating system, applications, and supporting configuration files and related data, that is located into a virtual server farm and executed for the benefit of the enterprise, with confidence that it will remain unchanged even when storage is added or removed. Thus, there is a need to provide a way to selectively associate and disassociate storage with a virtual server farm without modifying or disrupting the disk image or the operating system that is then in use by a particular enterprise, and without requiring a host to reboot.

Still another problem in this context relates to making back-up copies of data on the storage devices. It would be cumbersome and time-consuming for an operator of a data center to move among multiple data storage locations in order to accomplish a periodic back-up of data stored in the data storage locations. Thus there is a need for a way to provide storage that can be selectively associated with and disassociated from a virtual server farm and also backed up in a practical manner.

A specialized problem in this context arises from use of centralized arrays of fibrechannel (FC) storage devices in connection with processors that boot from small computer system interface (SCSI) ports. The data center that hosts virtual server farms may wish to implement storage using one or more FC disk storage arrays at a centralized location. The data center also hosts a plurality of processing hosts, which act as computing elements of the virtual server farms, and are periodically associated with disk units. The hosts are configured in firmware or in the operating system to always boot from SCSI port zero. However, in past approaches there has been no way to direct the processor to boot from a specified disk logical unit (LUN), volume or concatenated volume in a centralized disk array that is located across a network. Thus, there is a need for a way to map an arbitrary FC device into the SCSI address space of a processor so that the processor will boot from that FC device.

Based on the foregoing, there is a clear need in this field for a way to rapidly and automatically associate a data storage unit with a virtual server farm when storage is needed by the virtual server farm, and to disassociate the data storage unit from the virtual server farm when the data storage unit is no longer needed by that virtual server.

There is a specific need for a way to associate storage with a virtual server farm in a way that is secure.

There is also a need for a way to selectively associate storage with a virtual server farm without modifying or adversely affecting an operating system or applications of a particular enterprise that will execute in such virtual server farm for its benefit.

### SUMMARY OF THE INVENTION

The foregoing needs, and other needs that will become apparent from the following description, are achieved by the present invention, which comprises, in one aspect, an approach for dynamically associating computer storage with hosts using a virtual storage layer. A request to associate the storage is received at a virtual storage layer that is coupled to a plurality of storage units and to one or more hosts. The one or more hosts may have no currently assigned storage, or may have currently assigned storage, but require additional storage. The request identifies a particular host and an amount of requested storage. One or more logical units from among the storage units having the requested amount of storage are mapped to the identified host, by reconfiguring the virtual storage layer to logically couple the logical units to the identified host.

According to one feature, one or more logical units are mapped to a standard boot port of the identified host by reconfiguring the virtual storage layer to logically couple the logical units to the boot port of the identified host.

In another aspect, the invention provides a method for selectively logically associating storage with a processing host. In one embodiment, this aspect of the invention features mapping one or more disk logical units to the host using a storage virtualization layer, without affecting an operating system of the host or its configuration. Storage devices participate in storage area networks and are coupled to gateways. When a host needs storage to participate in a virtual server farm, software elements allocate one or more volumes or concatenated volumes of disk storage, assign the volumes or concatenated volumes to logical units (LUNs), and command the gateways and switches in the storage networks to logically and physically connect the host to the specified LUNs. As a result, the host acquires access to storage without modification to a configuration of the host, and a real-world virtual server farm or data center may be created and deployed substantially instantly.

In one feature, a boot port of the host is coupled to a direct-attached storage network that includes a switching fabric.

In another feature, the allocated storage is selected from among one or more volumes of storage that are defined in a database. In yet another feature, the allocated storage is selected from among one or more concatenated volumes that are defined in a database. Alternatively, the storage is allocated “on the fly” by determining what storage is then currently available in one or more storage units.

Other aspects encompass an apparatus and a computer-readable medium that are configured to carry out the foregoing steps.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram illustrating a top-level view of a process of defining a networked computer system;

FIG. 1B is a block diagram illustrating a more detailed view of the process of FIG. 1A;

FIG. 1C is a flow diagram of a process of deploying a data center based on a textual representation;

FIG. 1D is a block diagram showing a client and a service provider in a configuration that may be used to implement an embodiment;

FIG. 2A is a block diagram of an example server farm that is used to illustrate an example of the context in which such embodiments may operate;

FIG. 2B is a flow diagram that illustrates steps involved in creating such a table;

FIG. 2C is a block diagram illustrating a process of automatically modifying storage associated with an instant data center;

FIG. 3A is a block diagram of one embodiment of a virtual storage layer approach for dynamically associating computer storage devices with processors;

FIG. 3B is a block diagram of another embodiment of a virtual storage layer approach for dynamically associating computer storage devices with processors;

FIG. 3C is a block diagram of another embodiment of a virtual storage layer approach for dynamically associating computer storage devices with processors;

FIG. 4A is a block diagram of one embodiment of a storage area network;

FIG. 4B is a block diagram of an example implementation of a network attached storage network;

FIG. 4C is a block diagram of an example implementation of a direct attached storage network;

FIG. 5A is a block diagram illustrating interaction of the storage manager client and storage manager server;

FIG. 5B is a block diagram illustrating elements of a control database;

FIG. 6A is a block diagram of elements involved in creating a binding of a storage unit to a processor;

FIG. 6B is a flow diagram of a process of activating and binding a storage unit for a virtual server farm;

FIG. 7 is a state diagram illustrating states experienced by a disk unit in the course of the foregoing options;

FIG. 8 is a block diagram of software components that may be used in an example implementation a storage manager and related interfaces; and

FIG. 9 is a block diagram of a computer system that may be used to implement an embodiment.

### DETAILED DESCRIPTION OF THE PREFERRED EMBODIMENT

A virtual storage layer approach for dynamically associating computer storage devices to processors is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In this document, the terms “virtual server farm,” “VSF,” “instant data center,” and “IDC” are used interchangeably to refer to a networked computer system that comprises the combination of more than one processor, one or more storage devices, and one or more protective elements or management elements such as a firewall or load balancer, and that is created on demand from a large logical grid of generic computing elements and storage elements of the type described in Aziz et al. These terms explicitly exclude a single workstation, personal computer, or similar computer system consisting of a single box, one or more processors, storage device, and peripherals.

Embodiments are described in sections of this document that are organized according to the following outline:

1.0 FUNCTIONAL OVERVIEW

1.1 DEFINING AND INSTANTIATING AN INSTANT DATA CENTER

1.2 BUILDING BLOCKS FOR INSTANT DATA CENTERS

2.0 OVERVIEW OF INSTANTIATING DISK STORAGE BASED ON A SYMBOLIC DEFINITION OF AN INSTANT DATA CENTER

2.1 SYMBOLIC DEFINITION APPROACHES

2.2 INSTANTIATION OF DISK STORAGE BASED ON A SYMBOLIC DEFINITION

3.0 VIRTUAL STORAGE LAYER APPROACH FOR DYNAMICALLY ASSOCIATING COMPUTER STORAGE DEVICES WITH PROCESSORS

3.1 STRUCTURAL OVERVIEW OF FIRST EMBODIMENT

3.2 STRUCTURAL OVERVIEW OF SECOND EMBODIMENT

3.3 FUNCTIONAL OVERVIEW OF STORAGE MANAGER INTERACTION

3.4 DATABASE SCHEMA

3.5 SOFTWARE ARCHITECTURE

3.6 GLOBAL NAMESPACE FOR VOLUMES

4.0. HARDWARE OVERVIEW

1.0 Functional Overview

1.1 Defining and Instantiating an Instant Data Center

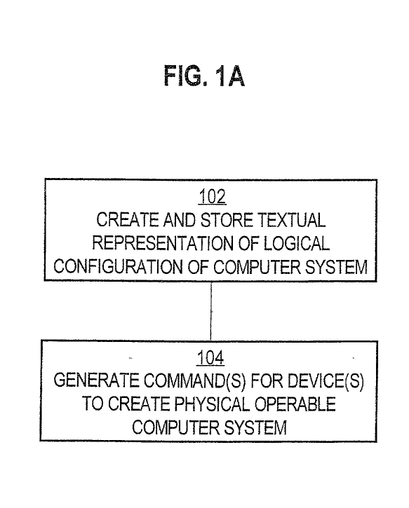

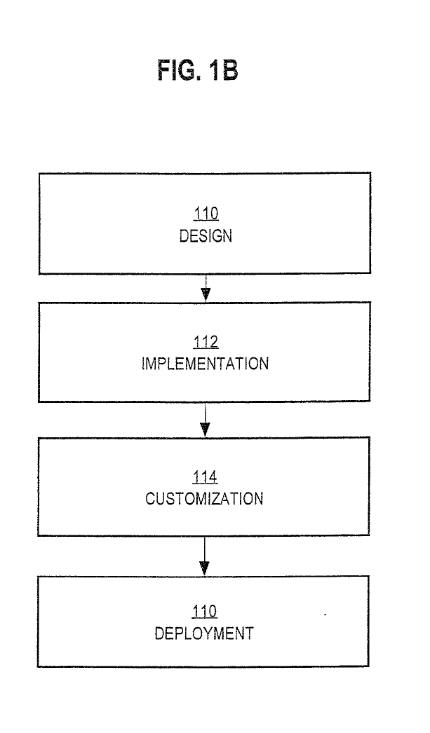

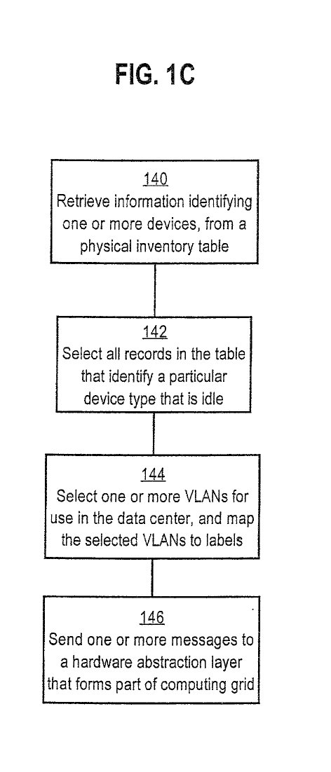

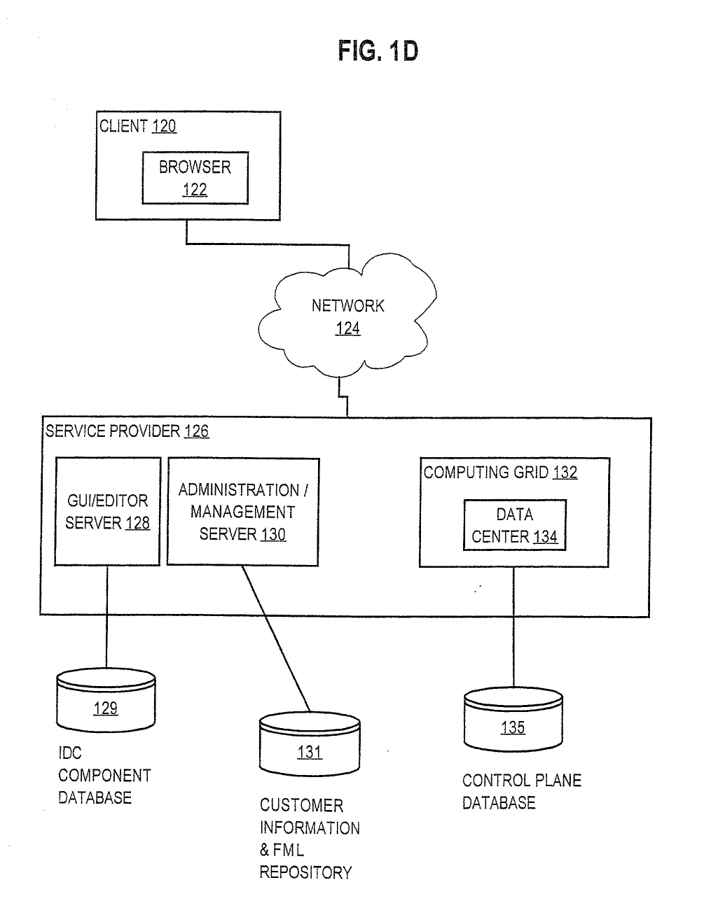

FIG. 1A is a block diagram illustrating an overview of a method of defining a networked computer system. A textual representation of a logical configuration of the computer system is created and stored, as shown in block 102. In block 104, one or more commands are generated, based on the textual representation, for one or more switch device(s). When the switch devices execute the commands, the networked computer system is created and activated by logically interconnecting computing elements. In the preferred embodiment, the computing elements form a computing grid as disclosed in Aziz et al.

FIG. 1B is a block diagram illustrating a more detailed view of the process of FIG. 1A. Generally, a method of creating a representation of a data center involves a Design phase, an Implementation phase, a Customization phase, and a Deployment phase, as shown by blocks 110, 112, 114, 116, respectively.

In the Design phase, a logical description of a data center is created and stored. Preferably, the logical description is created and stored using a software element that generates a graphical user interface that can be displayed by, and receive input from, a standard browser computer program. In this context, “browser” means a computer program that can display pages that conform to Hypertext Markup Language (HTML) or the equivalent, and that supports JavaScript and Dynamic HTML, e.g., Microsoft Internet Explorer, etc. To create a data center configuration, a user executes the graphical user interface tool. The user selects one or more icons representing data center elements (such as servers, firewalls, load balancers, etc.) from a palette of available elements. The end user drags one or more icons from the palette into a workspace, and interconnects the icons into a desired logical configuration for the data center.

In the Implementation phase of block 112, the user may request and receive cost information from a service provider who will implement the data center. The cost information may include, e.g., a setup charge, monthly maintenance fee, etc. The user may manipulate the icons into other configurations in response to analysis of the cost information. In this way, the user can test out various configurations to find one that provides adequate computing power at an acceptable cost.

In Customization phase of block, after a data center is created, a configuration program is used to add content information, such as Web pages or database information, to one or more servers in the data center that was created using the graphical user interface tool. In the Customization phase, the user may save, copy, replicate, and otherwise edit and manipulate a data center design. Further, the user may apply one or more software images to servers in the data center. The selection of a software image and its application to a server may be carried out in accordance with a role that is associated with the servers. For example, if a first server has the role Web Server, then it is given a software image of an HTTP server program, a CGI script processor, Web pages, etc. If the server has the role Database Server, then it is given a software image that includes a database server program and basic data. Thus, the user has complete control over each computer that forms an element of a data center. The user is not limited to use of a pre-determined site or computer.

In the Deployment phase of block 116, the data center that has been created by the user is instantiated in a computing grid, activated, and initiates processing according to the server roles.

FIG. 1C is a flow diagram of a process of deploying a data center based on a textual representation.

In block 140, the process retrieves information identifying one or more devices, from a physical inventory table. The physical inventory table is a database table of devices, connectivity, wiring information, and status, and may be stored in, for example, control plane database 135. In block 142, the process selects all records in the table that identify a particular device type that is idle. Selection of such records may be done, for example, in an SQL database server using a star query statement of the type available in the SQL language.

Database 131 also includes a VLAN table that stores up to 4096 entries. Each entry represents a VLAN. The limit of 4096 entries reflects the limits of Layer 2 information. In block 144, the process selects one or more VLANs for use in the data center, and maps the selected VLANs to labels. For example, VLAN value “11” is mapped to the label Outer_VLAN, and VLAN value “12” is mapped to the label Inner_VLAN.

In block 146, the process sends one or more messages to a hardware abstraction layer that forms part of computing grid 132. Details of the hardware abstraction layer are set forth in Aziz et al. The messages instruct the hardware abstraction layer how to place CPUs of the computing grid 132 in particular VLANs. For example, a message might comprise the information, “Device ID=5,” “Port (or Interface)=eth0,” “vlan=v1.” An internal mapping is maintained that associates port names (such as “eth0” in this example) with physical port and blade number values that are meaningful for a particular switch. In this example, assume that the mapping indicates that port “eth0” is port 1, blade 6 of switch device 5. Further, a table of VLANs stores a mapping that indicates that “v1” refers to actual VLAN “5”. In response, the process would generate messages that would configure port 1, blade 6 to be on VLAN 5. The particular method of implementing block 146 is not critical. What is important is that the process sends information to computing grid 132 that is sufficient to enable the computing grid to select and logically interconnect one or more computing elements and associated storage devices to form a data center that corresponds to a particular textual representation of the data center.

FIG. 1D is a block diagram showing a client and a service provider in a configuration that may be used to implement an embodiment. Client 120 executes a browser 122, which may be any browser software that supports JavaScript and Dynamic HTML, e.g., Internet Explorer. Client 120 communicates with service provider 126 through a network 124, which may be a local area network, wide area network, one or more internetworks, etc.

Service provider 126 is associated with a computing grid 132 that has a large plurality of processor elements and storage elements, as described in Aziz et al. With appropriate instructions, service provider 126 can create and deploy one or more data centers 134 using elements of the computing grid 132. Service provider also offers a graphical user interface editor server 128, and an administration/management server 130, which interact with browser 122 to provide data center definition, management, re-configuration, etc. The administration/management server 130 may comprise one or more autonomous processes that each manage one or more data centers. Such processes are referred to herein as Farm Managers. Client 120 may be associated with an individual or business entity that is a customer of service provider 126.

1.2 Building Blocks for Instant Data Centers

As described in detail in Aziz et al., a data center may be defined in terms of a number of basic building blocks. By selecting one or more of the basic building blocks and specifying interconnections among the building blocks, a data center of any desired logical structure may be defined. The resulting logical structure may be named and treated as a blueprint (“DNA”) for creating any number of other IDCs that have the same logical structure. Thus, creating a DNA for a data center facilitates the automation of many manual tasks involved in constructing server farms using prior technologies.

As defined herein, a data center DNA may specify roles of servers in a data center, and the relationship of the various servers in the roles. A role may be defined once and then re-used within a data center definition. For example, a Web Server role may be defined in terms of the hardware, operating system, and associated applications of the server, e.g., dual Pentium of a specified minimum clock rate and memory size, NT version 4.0, Internet Information Server version 3.0 with specified plug-in components. This Web Server role then can be cloned many times to create an entire Web server tier. The role definition also specifies whether a role is for a machine that is statically assigned, or dynamically added and removed from a data center.

One basic building block of a data center is a load balancing function. The load-balancing function may appear at more than one logical position in a data center. In one embodiment, the load-balancing function is implemented using the hardware load-balancing function of the L2-7 switching fabric, as found in ServerIron switches that are commercially available from Foundry Networks, Inc., San Jose, Calif. A single hardware load-balancing device, such as the Server Iron product that is commercially available from Foundry, can provide multiple logical load balancing functions. Accordingly, a specification of a logical load-balancing function generally comprises a virtual Internet Protocol (VIP) address value, and a load-balancing policy value (e.g., “least connections” or “round robin”). A single device, such as Foundry ServerIron, can support multiple VIPs and different policies associated with each VIP. Therefore, a single Foundry Server Iron device can be used in multiple logical load balancing positions in a given IDC.

One example use of a load-balancing function is to specify that a Web server tier is load balanced using a particular load-balancing function. For example, a two-tier IDC may have a Web server tier with a database server tier, with load balancing of this type. When a tier is associated with a load balancer, automatic processes update the load balancer in response to a user adding or removing a server to or from the server tier. In an alternative embodiment, other devices are also automatically updated.

Another example use of a load-balancing function is to specify a load-balancing function for a tier of application servers, which are logically situated behind the load-balanced Web server tier, in a 3-tier configuration. This permits clustering of the application server tier to occur using hardware load balancing, instead of application specific load balancing mechanisms. This approach may be combined with application-specific clustering mechanisms. Other building blocks include firewalls, servers, storage, etc.

2.0 Overview of Instantiating Disk Storage Based on A Symbolic Definition of an Instant Data Center

2.1 Symbolic Definition Approaches

Approaches for symbolic definition of a virtual computer system are described in co-pending application Ser. No. (Not Yet Assigned), filed Mar. 26, 2001, of Ashar Aziz et al. In that description, a high-level symbolic markup language is disclosed for use, among other tasks, in defining disk storage associated with an instant data center. In particular, a disk definition is provided. A disk definition is part of a server-role definition. A disk definition comprises a drivename value, drivesize value, and drivetype value. The drivename value is a mandatory, unique name for the disk. The drivesize value is the size of the disk in Megabytes. The drivetype value is the mirroring type for the disk. For example, standard mirroring (specified using the value “std”) may be specified.

As a usage example, the text <disk drivename=“/test” drivesize=200 drivetype=“std” /> defines a 200 Mb disk map on /test. One use of such a definition is to specify an extra local storage drive (e.g., a D: drive) as part of a Windows or Solaris machine. This is done using the optional disk attribute of a server definition. For example, the following element in a server definition specifies a server with a local drive named d: with a capacity of 200 MB.

<disk drivename=“D:”, drivesize=“200”>
</disk>

Although the drive name “D:” is given in the foregoing definition, for the purpose of illustrating a specific example, use of such a name format is not required. The drivename value may specify a SCSI drive name value or a drive name in any other appropriate format. In a Solaris/Linux environment, the disk attribute can be used to specify, e.g. an extra locally mounted file system, such as /home, as follows:

<disk drivename=“/home”, drivesize=“512”>
</disk>

In an alternative approach, the <disk></disk> tags refer to disk using SCSI target numbers, rather than file system mount points. For example, a disk definition may comprise the syntax:

<disk target=“0” drivetype=“scsi” drivesize=“8631”>

This indicates that, for the given server role, a LUN of size 8631 MB should be mapped to the SCSI drive at target 0 (and LUN 0). Thus, rather than referring to information at the file system layer, the disk tag refers to information directly at the SCSI layer. A complete example farm definition using the disk tag is given below.

<?xml version=“1.0”?>
<farm fmlversion=“1.1”>

<tier id=“37” name=“Server1”>

<interface name=“eth0” subnet=“subnet17” />
<role>role37</role>
<min-servers>1</min-servers>
<max-servers>1</max-servers>
<init-servers>1</init-servers>

</tier>
<server-role id=“role37” name=“Server1”>

<hw>cpu-sun4u-x4</hw>
<disk target=“0” drivetype=“scsi” drivesize=“8631”>

<diskimage type=“system”>solaris</diskimage>
<attribute name=“backup-policy” value=“nightly” />

</disk>

</server-role>
<subnet id=“subnet17” name=“Internet1” ip=“external”
mask=“255.255.255.240” vlan=“outer-vlan” />

</farm>

2.2 Instantiation of Disk Storage Based on A Symbolic Definition

In one approach, to implement or execute this definition, the Farm Manager allocates the correct disk space on a SAN-attached device and maps the space to the right machine using the processes described herein. Multiple disk attributes can be used to specify additional drives (or partitions from the point of view of Unix operating environments).

The disk element may also include one or more optional attributes for specifying parameters such as RAID levels, and backup policies, using the attribute element. Examples of the attribute names and values are given below.

<disk drivename=“/home”, drivesize=“512MB”>

<attribute name=“raid-level”, value=“0+1”>
<attribute name=“backup-policy”, value=“level=0:nightly”>
<attribute name=“backup-policy”, value=“level=1:hourly”>

</disk>

The above specifies that /home should be located on a RAID level 0+1 drive, with a level 0 backup occurring nightly and a level 1 backup occurring every hour. Over time, other attributes may be defined for the disk partition.

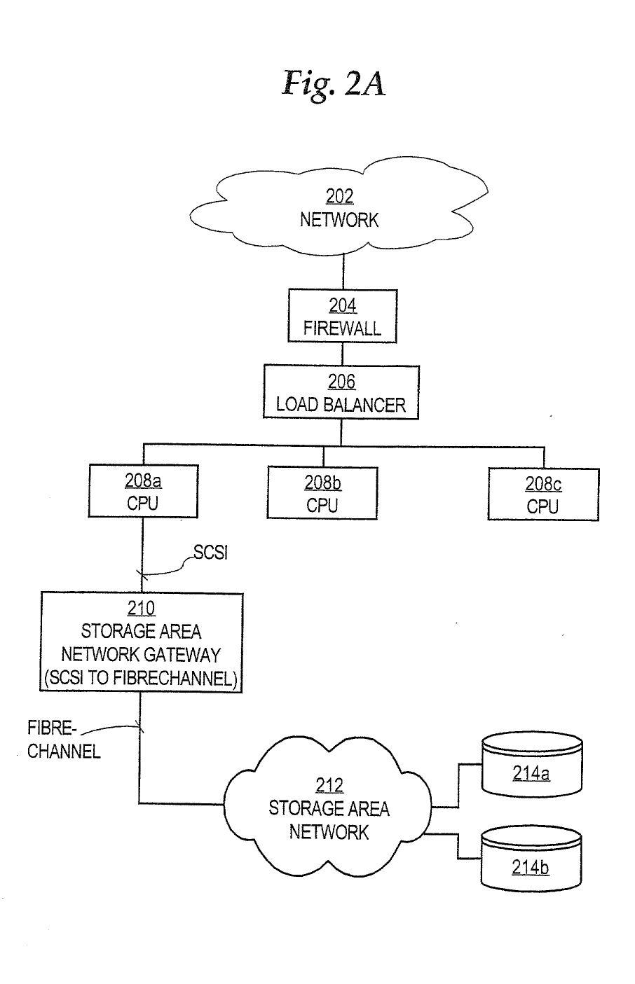

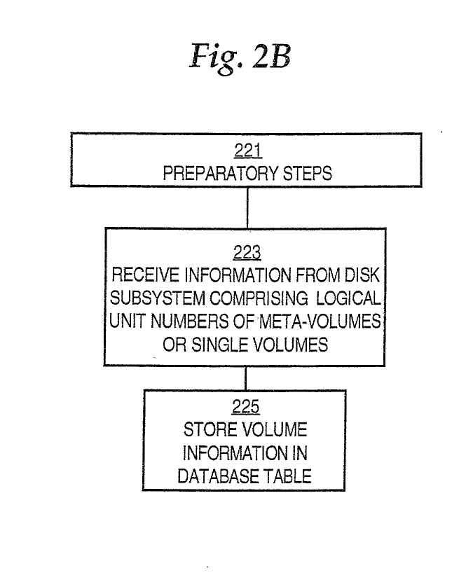

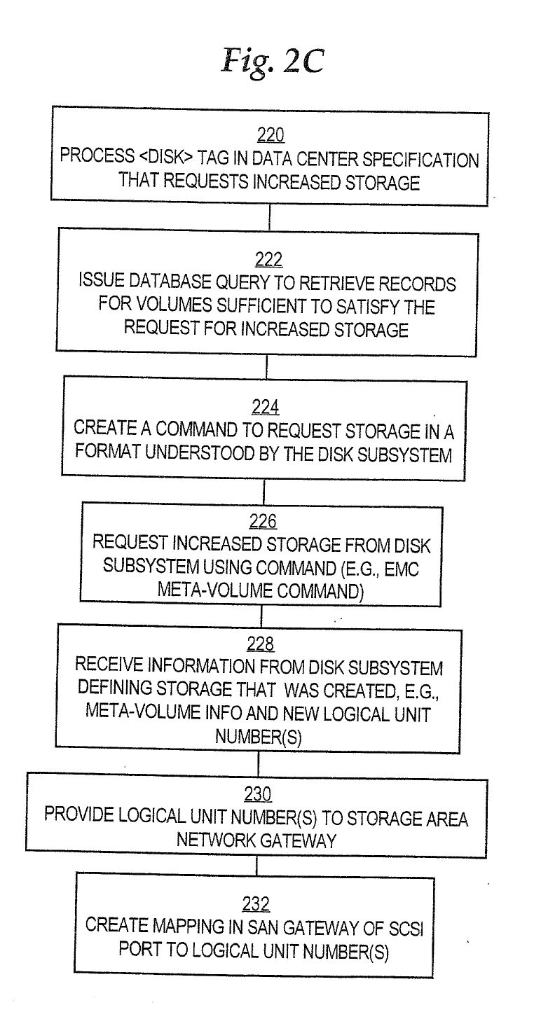

Embodiments can process disk tags as defined herein and automatically increase or decrease the amount of storage associated with a data center or server farm. FIG. 2A is a block diagram of an example server farm that is used to illustrate an example of the context in which such embodiments may operate. Network 202 is communicatively coupled to firewall 204, which directs authorized traffic from the network to load balancer 206. One or more CPU devices 208a, 208b, 208c are coupled to load balancer 206 and receive client requests from network 202 according to an order or priority determined by the load balancer.

Each CPU in the data center or server farm is associated with storage. For purposes of illustrating a clear example, FIG. 2A shows certain storage elements in simplified form. CPU 208a is coupled by a small computer system interface (SCSI) link to a storage area network gateway 210, which provides an interface for CPUs with SCSI ports to storage devices or networks that use fibrechannel interfaces. In one embodiment, gateway 210 is a Pathlight gateway and can connect to 1-6 CPUs. The gateway 210 has an output port that uses fibrechannel signaling and is coupled to storage area network 212. One or more disk arrays 214a, 214b are coupled to storage area network 212. For example, EMC disk arrays are used.

Although FIG. 2A illustrates a connection of only CPU 208a to the gateway 210, in practice all CPUs of the data center or server farm are coupled by SCSI connections to the gateway, and the gateway thereby manages assignment of storage of storage area network 212 and disk arrays 214a, 214b for all the CPUs.

A system in this configuration may have storage automatically assigned and removed based on an automatic process that maps portions of storage in disk arrays 214a, 214b to one or more of the CPUs. In an embodiment, the process operates in conjunction with a stored data table that tracks disk volume information. For example, in one embodiment of a table, each row is associated with a logical unit of storage, and has columns that store the logical unit number, size of the logical unit, whether the logical unit is free or in use by a CPU, the disk array on which the logical unit is located, etc.

FIG. 2B is a flow diagram that illustrates steps involved in creating such a table. As indicated by block 221, these are preparatory steps that are normally carried out before the process of FIG. 2C. In block 223, information is received from a disk subsystem, comprising one or more logical units (LUNs) associated with one or more volumes or concatenated volumes of storage in the disk subsystem. Block 223 may involve receiving unit information from disk arrays 214a, 214b, or a controller that is associated with them. The information may be retrieved by sending appropriate queries to the controller or arrays. In block 225, the volume information is stored in a table in a database. For example, an Oracle database may contain appropriate tables.

The process of FIG. 2B may be carried out upon initialization of an instant data center, or continuously as one or more data centers are in operation. As a result, the process of FIG. 2C continuously has available to it a picture of the size of available storage in a storage subsystem that serves the CPUs of the server farm.

FIG. 2C is a block diagram illustrating a process of automatically modifying storage associated with an instant data center. For purposes of illustrating a clear example, the process of FIG. 2C is described in relation to the context of FIG. 2A, although the process may be used in any other appropriate context.

In block 220, a <disk> tag in a data center specification that requests increased storage is processed. Block 220 may involve parsing a file that specifies a data center or server farm in terms of the markup language described herein, and identifying a statement that requests a change in storage for a server farm.

In block 222, a database query is issued to retrieve records for free storage of an amount sufficient to satisfy the request for increased storage that is contained in the data center specification or disk tag. For example, where the disk tag specifies 30 Mb of disk storage, a SELECT query is issued to the database table described above to select and retrieve copies of all records of free volumes that add up to 30 Mb or more of storage. When a result set is received from the database, a command to request that amount of storage in the specified volumes is created, in a format understood by the disk subsystem, as shown by block 224. Where EMC disk storage is used, block 224 may involve formulating a meta-volume command that a particular amount of storage that can satisfy what is requested in the disk tag.

In block 226, a request for increased storage is made to the disk subsystem, using the command that was created in block 224. Thus, block 226 may involve sending a meta-volume command to disk arrays 214a, 214b. In block 228, the process receives information from the disk subsystem confirming and identifying the amount of storage that was allocated and its location in terms of logical unit numbers. In one embodiment, the concatenated volumes may span more than one disk array or disk subsystem, and the logical unit numbers may represent storage units in multiple hardware units.

In block 230, the received logical unit numbers are provided to storage area network gateway 210. In response, storage area network gateway 210 creates an internal mapping of one of its SCSI ports to the logical unit numbers that have been received. As a result, the gateway 210 can properly direct information storage and retrieval requests arriving on any of its SCSI ports to the correct disk array and logical unit within a disk subsystem. Further, allocation or assignment of storage to a particular CPU is accomplished automatically, and the amount of storage assigned to a CPU can increase or decrease over time, based on the textual representations that are set forth in a markup language file.

3.0 Virtual Storage Layer Approach for Dynamically Associating Computer Storage Devices With Processors

3.1 Structural Overview of First Embodiment

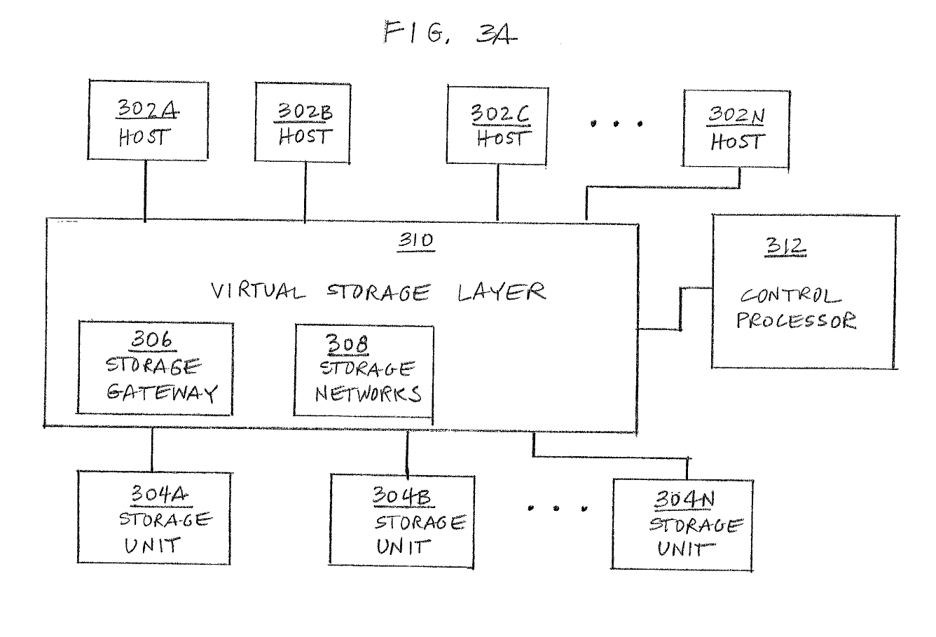

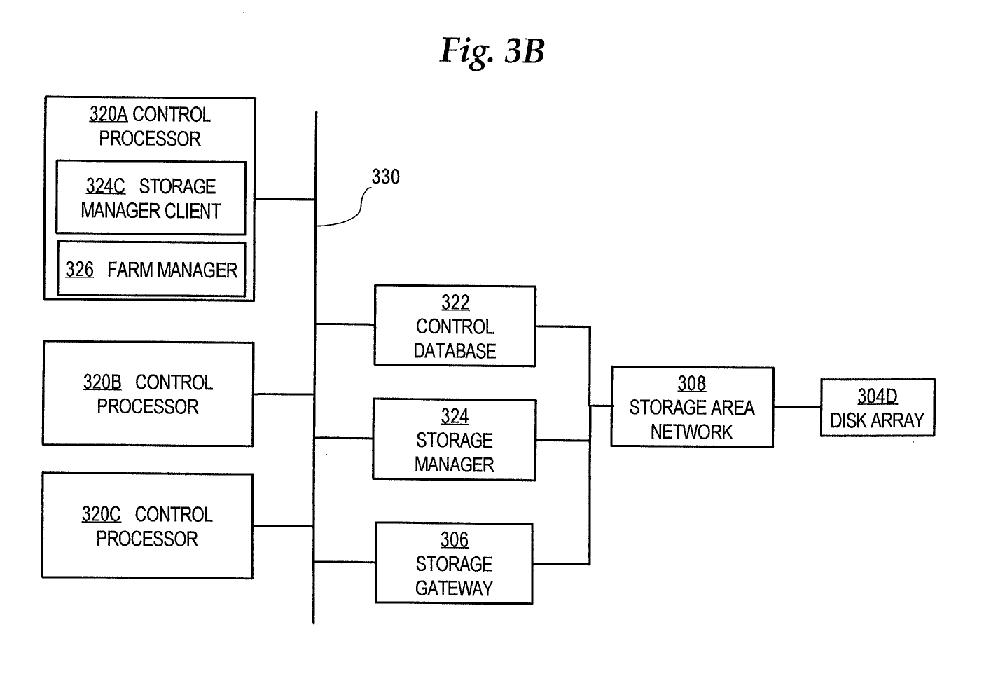

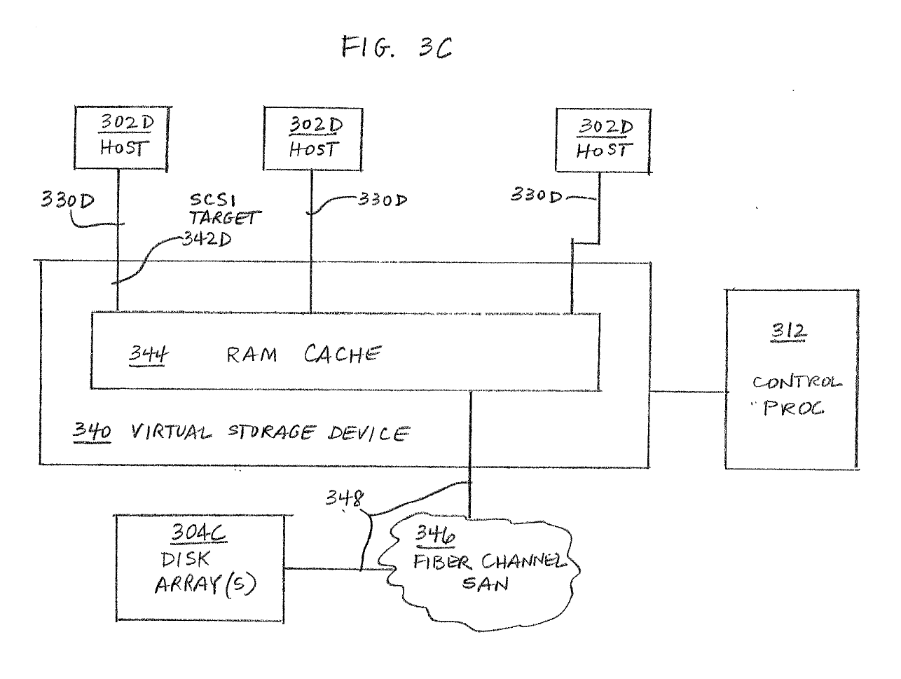

FIG. 3A is a block diagram of one embodiment of an approach for dynamically associating computer storage with hosts using a virtual storage layer. In general, a virtual storage layer provides a way to dynamically and selectively associate storage, including boot disks and shared storage, with hosts as the hosts join and leave virtual server farms, without adversely affecting host elements such as the operating system and applications, and without host involvement.

A plurality of hosts 302A, 302B, 302N, etc., are communicatively coupled to a virtual storage layer 310. Each of the hosts 302A, 302B, 302N, etc. is a processing unit that can be assigned, selectively, to a virtual server farm as a processor, load balancer, firewall, or other computing element. A plurality of storage units 304A, 304B, 304N, etc. are communicatively coupled to virtual storage layer 310.

Each of the storage units 304A, 304B, 304N, etc., comprises one or more disk subsystems or disk arrays. Storage units may function as boot disks for hosts 302A, etc., or may provide shared content at the block level or file level for the hosts. The kind of information stored in a storage unit that is associated with a host determines a processing role of the host. By changing the boot disk to which a host is attached, the role of the host may change. For example, a host may be associated with a first boot disk that contains the Windows 2000 operating system for a period of time, and then such association may be removed and the same host may be associated with a second boot disk that contains the LINUX operating system. As a result, the host becomes a LINUX server. A host can run different kinds of software as part of the boot process in order to determine whether it is a Web server, a particular application server, etc. Thus, a host that otherwise has no specific processing role may acquire a role through a dynamic association with a storage device that contains specific boot disk information or shared content information.

Each storage unit is logically divisible into one or more logical units (LUNs) that can be assigned, selectively, to a virtual server farm. A LUN may comprise a single disk volume or a concatenated volume that comprises multiple volumes. Thus, storage of any desired size may be allocated from a storage unit by either allocating a volume and assigning the volume to a LUN, or instructing the storage unit to create a concatenated volume that comprises multiple volumes, and then assigning the concatenated volume to a LUN. LUNs from different storage units may be assigned in any combination to a single virtual server farm to satisfy the storage requirements of the virtual server farm. In one embodiment, a LUN may comprise a single disk volume or a concatenated volume that spans more than one storage 10 unit or disk array.

Virtual storage layer 310 establishes dynamic associations among the storage devices and hosts. In one embodiment, virtual storage layer 310 comprises one or more storage gateways 306 and one or more storage area networks 308. The virtual storage layer 310 is communicatively coupled to a control processor 312. Under control of executable program logic as further described herein, control processor 312 can command storage gateways 306 and storage area networks 308 to associate a particular LUN of one or more of the storage units 304A, 304B, 304N, etc. with a particular virtual server farm, e.g., to a particular host 302A, 302B, 302N. Control processor 312 may comprise a plurality of processors and supporting elements that are organized in a control plane.

In this arrangement, virtual storage layer 310 provides storage virtualization from the perspective of hosts 302A, etc. Each such host can obtain storage through virtual storage layer 310 without determining or knowing which specific storage unit 304A, 304B, 304N, etc., is providing the storage, and without determining or knowing which LUN, block, volume, concatenated, or other sub-unit of a storage unit actually contains data. Moreover, LUNs of the storage units may be mapped to a boot port of a particular host such that the host can boot directly from the mapped LUN without modification to the applications, operating system, or configuration data executed by or hosted by the host. In this context, “mapping” refers to creating a logical assignment or logical association that results in establishing an indirect physical routing, coupling or connection of a host and a storage unit.

Virtual storage layer 310 enforces security by protecting storage that is part of one virtual server farm from access by hosts that are part of another virtual server farm.

The virtual storage layer 310 may be viewed as providing a virtual SCSI bus that maps or connects LUNs to hosts. In this context, virtual storage layer 310 appears to hosts 302A, 302B, 302N as a SCSI device, and is addressed and accessed as such. Similarly, virtual storage layer 310 appears to storage units 304A, 304B, 304N as a SCSI initiator.

Although embodiments are described herein in the context of SCSI as a communication interface and protocols, any other suitable interfaces and protocols may be used. For example, iSCSI may be used, fibre channel communication may pass through the gateways, etc. Further, certain embodiments are described herein in the context of LUNs, volumes, and concatenated volumes or meta-volumes. However, the invention is not limited to this context, and is applicable to any form of logical or physical organization that is used in any form of mass storage device now known or hereafter invented.

FIG. 3B is a block diagram of another embodiment of an approach for dynamically associating computer storage with processors using a virtual storage layer.

One or more control processors 320A, 320B, 320N, etc. are coupled to a local area network 330. LAN 330 may be an Ethernet network, for example. A control database 322, storage manager 324, and storage gateway 306A are also coupled to the network 330. A storage area network (SAN) 308A is communicatively coupled to control database 322, storage manager 324, and storage gateway 306A, as well as to a storage unit 304D. The control processors and control database may be organized with other supporting elements in a control plane.

In one embodiment, each control processor 320A, 320B, 320N, etc. executes a storage manager client 324C that communicates with storage manager 324 to carry out storage manager functions. Further, each control processor 320A, 320B, 320N, etc. executes a farm manager 326 that carries out virtual server farm management functions. In one specific embodiment, storage manager client 324C provides an API with which a farm manager 326 can call functions of storage manager 324 to carry out storage manager functions. Thus, storage manager 324 is responsible for carrying out most basic storage management functions such as copying disk images, deleting information (“scrubbing”) from storage units, etc. Further, storage manager 324 interacts directly with storage unit 304D to carry out functions specific to the storage unit, such as giving specified gateways access to LUNs, creating logical concatenated s, associating volumes or concatenated volumes with LUNs, etc.

Certain binding operations involving storage gateway 306A are carried out by calls of the farm manager 326 to functions that are defined in an API of storage gateway 306A. In particular, the storage gateway 306A is responsible for connecting hosts to fibrechannel switching fabrics to carry out associations of hosts to storage devices.

In the configuration of FIG. 3A or FIG. 3B, control processors 320A, 320B, 320N also may be coupled to one or more switch devices that are coupled, in turn, to hosts for forming virtual server farms therefrom. Further, one or more power controllers may participate in virtual storage layer 310 or may be coupled to network 330 for the purpose of selectively powering-up and powering-down hosts 302.

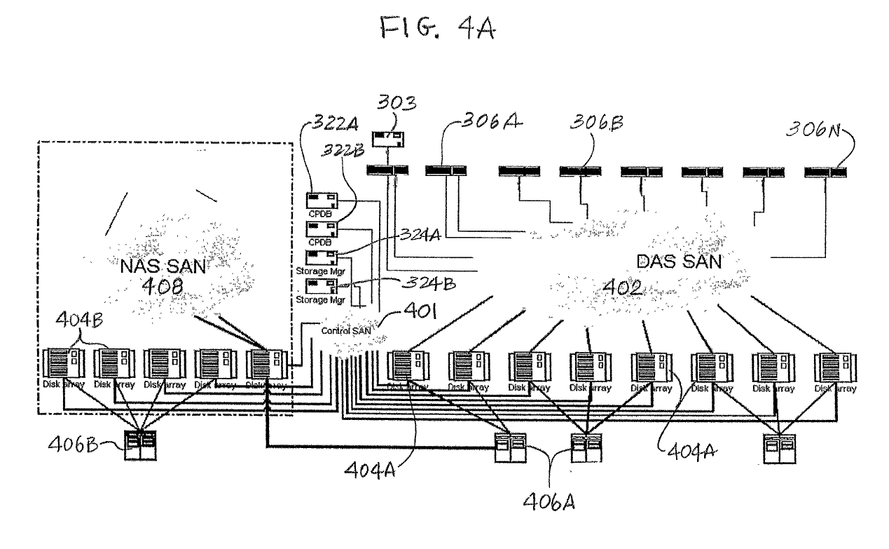

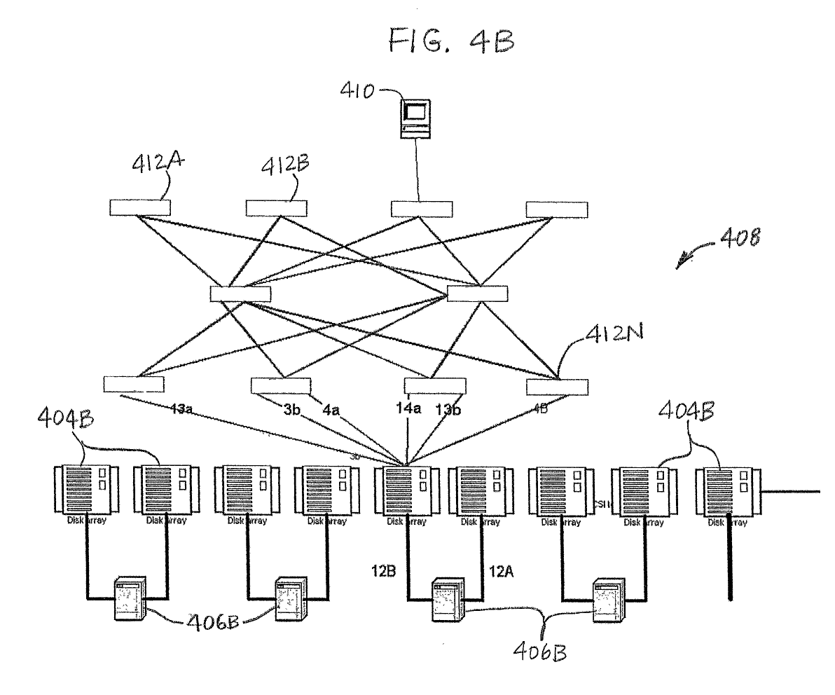

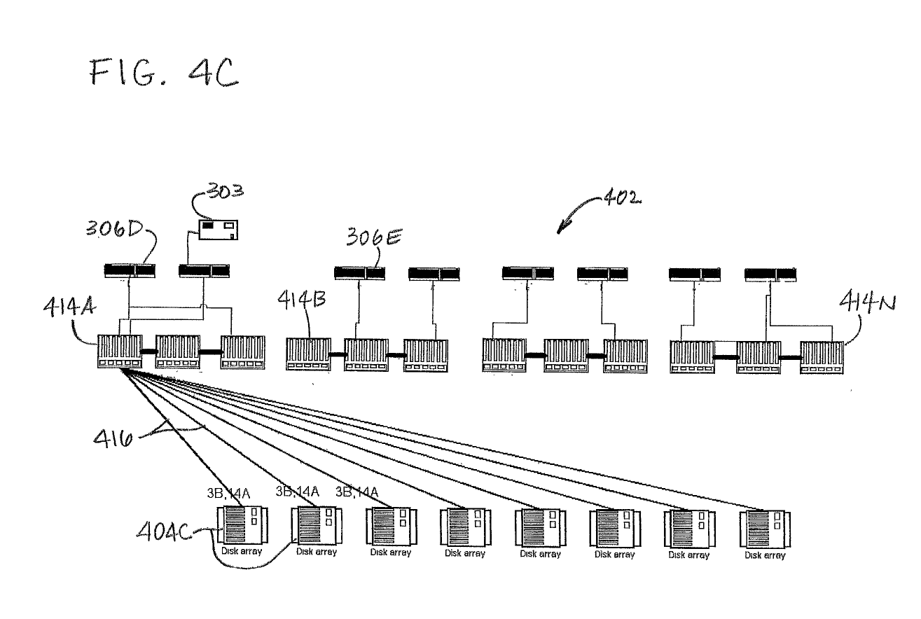

FIG. 4A is a block diagram of one embodiment of storage area network 308A. In this embodiment, storage area network 308A is implemented as two networks that respectively provide network attached storage (NAS) and direct attached storage (DAS).

One or more control databases 322A, 322B are coupled to a control network 401. One or more storage managers 324A, 324B also are coupled to the control network 401. The control network is further communicatively coupled to one or more disk arrays 404A, 404B that participate respectively in network attached storage network 408 and direct attached storage network 402.

In one embodiment, network attached storage network 408 comprises a plurality of data movement servers that can receive network requests for information stored in storage units 404B and respond with requested data. A disk array controller 406B is communicatively coupled to the disk arrays 404B for controlling data transfer among them and the NAS network 408. In one specific embodiment, EMC Celerra disk arrays are used

A plurality of storage gateways 306A, 306B, 306N, etc., participate in a direct attached storage network 402. A plurality of the disk arrays 404A are coupled to the DAS network 402. The DAS network 402 comprises a plurality of switch devices. Each of the disk arrays 404A is coupled to at least one of the switch devices, and each of the storage gateways is coupled to one of the switch devices. One or more disk array controllers 406A are communicatively coupled to the disk arrays 404A for controlling data transfer among them and the DAS network 402. Control processors manipulate volume information in the disk arrays and issue commands to the storage gateways to result in binding one or more disk volumes to hosts for use in virtual server farms.

Symmetrix disk arrays commercially available from EMC (Hopkinton, Mass.), or similar units, are suitable for use as disk arrays 404B. EMC Celerra storage may be used for disk arrays 404A. Storage gateways commercially available from Pathlight Technology, Inc./ADIC (Redmond, Wash.), or similar units, are suitable for use as storage gateways 306A, etc. Switches commercially available from McDATA Corporation (Broomfield, Colo.) are suitable for use as a switching fabric in DAS network 402.

The storage gateways provide a means to couple a processor storage port, including but not limited to a SCSI port, to a storage device, including but not limited to a storage device that participates in a fibrechannel network. In this configuration, the storage gateways also provide a way to prevent WWN (Worldwide Name) “Spoofing,” where an unauthorized server impersonates the address of an authorized server to get access to restricted data. The gateway can be communicatively coupled to a plurality of disk arrays, enabling virtual access to a large amount of data through one gateway device. Further, in the SCSI context, the storage gateway creates a separate SCSI namespace for each host, such that no changes to the host operating system are required to map a disk volume to the SCSI port(s) of the host. In addition, the storage gateway facilitates booting the operating system from centralized storage, without modification of the operating system.

Control network 401 comprises a storage area network that can access all disk array volumes. In one embodiment, control network 401 is configured on two ports of all disk arrays 404A, 404B. Control network 401 is used for copying data within or between disk arrays; manipulating disk array volumes; scrubbing data from disks; and providing storage for the control databases.

FIG. 4B is a block diagram of an example implementation of network attached storage network 408.

In this embodiment, network attached storage network 408 comprises a plurality of data movement servers 410 that can receive network requests for information stored in storage units 404B and respond with requested data. In one embodiment, there are 42 data movement servers 410. Each data movement server 410 is communicatively coupled to at least one of a plurality of switches 412A, 412B, 412N, etc. In one specific embodiment, the switches are Brocade switches. Each of the switches 412A, 412B, 412N, etc. has one or more ports that are coupled to one of a plurality of the disk arrays 404B. Pairs of disk arrays 404B are coupled to a disk array controller 406B for controlling data transfer among them and the NAS network 408.

FIG. 4C is a block diagram of an example implementation of direct attached storage network 402.

In this embodiment, at least one server or other host 303 is communicatively coupled to a plurality of gateways 306D, 306E, etc. Each of the gateways is communicatively coupled to one or more data switches 414A, 414B. Each of the switches is communicatively coupled to a plurality of storage devices 404C by links 416. In one specific embodiment, the switches are McDATA switches.

Each of the switches 414A, 414B, etc. has one or more ports that are coupled to one of a plurality of the disk arrays 404C. Pairs of ports identify various switching fabrics that include switches and disk arrays. For example, in one specific embodiment, a first fabric is defined by switches that are coupled to standard ports “3A” and “14B” of disk arrays 404C; a second fabric is defined by switches coupled to ports “4A,” “15B,” etc.

3.2 Structural Overview of Second Embodiment

FIG. 3C is a block diagram of a virtual storage layer approach according to a second embodiment. A plurality of hosts 302D are communicatively coupled by respective SCSI channels 330D to a virtual storage device 340. Virtual storage device 340 has a RAM cache 344 and is coupled by one or more fiber-channel storage area networks 346 to one or more disk arrays 304C. Links 348 from the virtual storage device 340 to the fiber channel SAN 346 and disk arrays 304C are fiber channel links.

Virtual storage device 340 is communicatively coupled to control processor 312, which performs steps to map a given logical disk to a host. Logical disks may be mapped for shared access, or for exclusive access. An example of an exclusive access arrangement is when a logical disk acts as a boot disk that contains unique per-server configuration information.

In this configuration, virtual storage device 340 acts in SCSI target mode, as indicated by SCSI target connections 342D providing the appearance of an interface of a SCSI disk to a host that acts in SCSI initiator mode over SCSI links 330D. The virtual storage device 340 can interact with numerous hosts and provides virtual disk services to them.

Virtual storage device 340 may perform functions that provide improved storage efficiency and performance efficiency. For example, virtual storage device 340 can sub-divide a single large RAID disk array into many logical disks, by performing address translation of SCSI unit numbers and block numbers in real time. As one specific example, multiple hosts may make requests to SCSI unit 0, block 0. The requests may be mapped to a single disk array by translating the block number into an offset within the disk array. This permits several customers to share a single disk array by providing many secure logical partitions of the disk array.

Further, virtual storage device 340 can cache disk data using its RAM cache 344. In particular, by carrying out the caching function under control of control processor 312 and policies established at the control processor, the virtual storage device can provide RAM caching of operating system paging blocks, thereby increasing the amount of fast virtual memory that is available to a particular host.

3.3 Functional Overview of Storage Manager Interaction

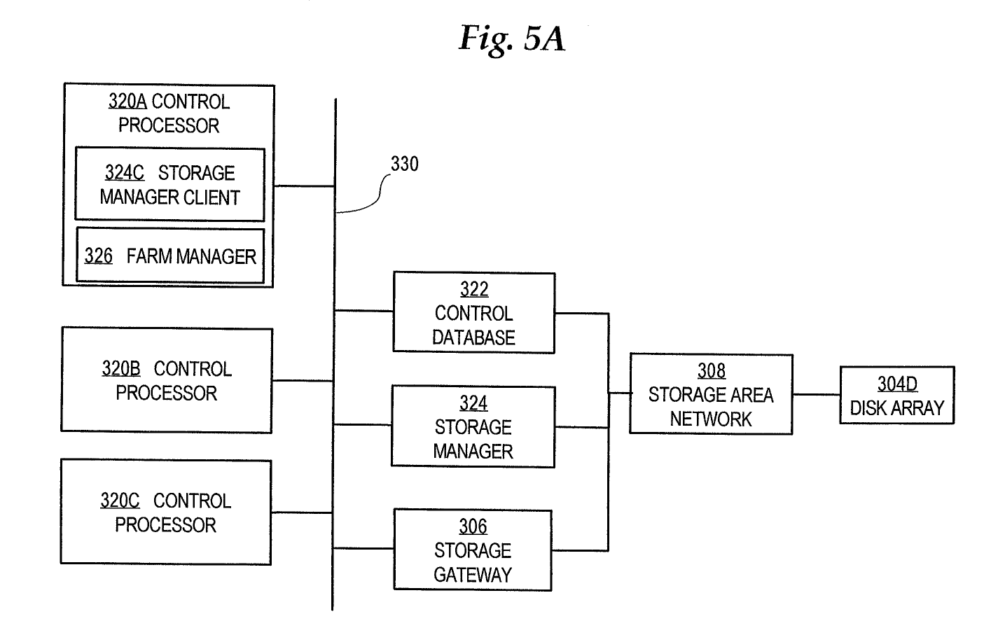

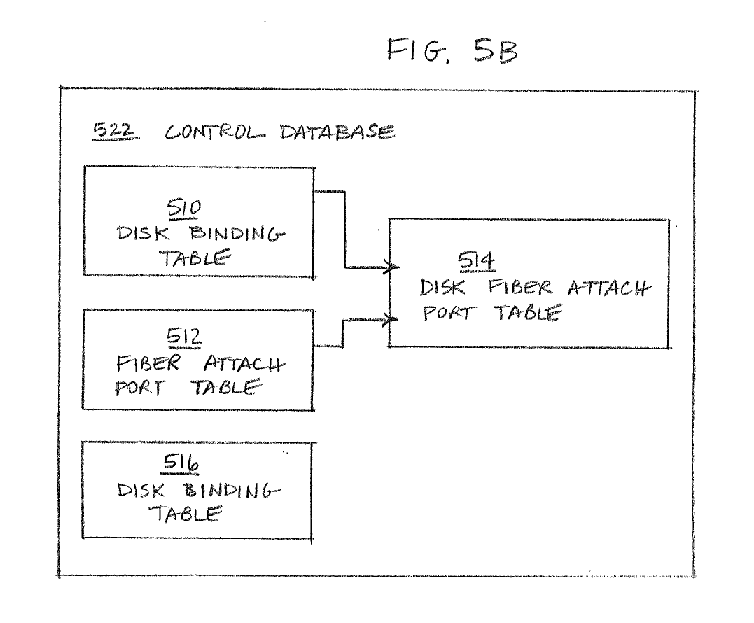

FIG. 5A is a block diagram illustrating interaction of the storage manager client and storage manager server.

In this example embodiment, a control processor 320A comprises a computing services element 502, storage manager client 324C, and a gateway hardware abstraction layer 504. Computing services element 502 is a sub-system of a farm manager 326 that is responsible to call storage functions for determining allocation of disks, VLANs, etc. The storage manager client 324C is communicatively coupled to storage manager server 324 in storage manager server machine 324A. The gateway hardware abstraction layer 504 is communicatively coupled to storage gateway 306A and provides a software interface so that external program elements can call functions of the interface to access hardware functions of gateway 306A. Storage manager server machine 324A additionally comprises a disk array control center 506, which is communicatively coupled to disk array 304D, and a device driver 508. Requests for storage management services are communicated from storage manager client 324C to storage manager 324 via network link 510.

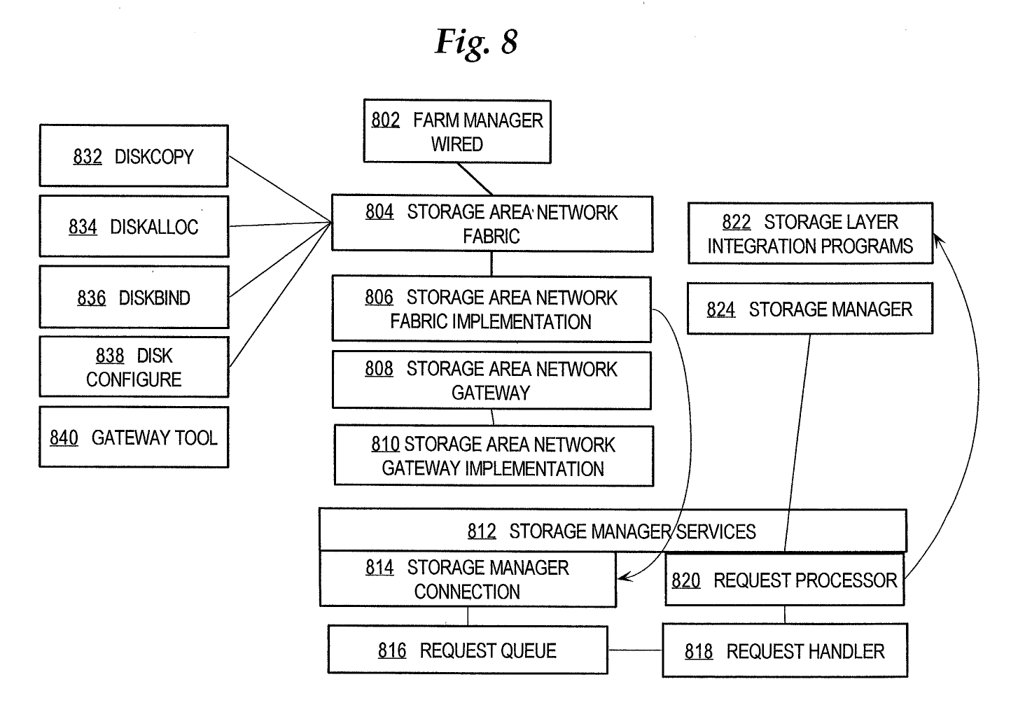

Details of the foregoing elements are also described herein in connection with FIG. 8.

In this arrangement, storage manager server 324 implements an application programming interface with which storage manager client 324C can call one or more of the following functions:

Discovery

Bind

Scrub

Copy

Snap

Meta Create

The Discovery command, when issued by a storage manager client 324C of a control processor to the storage manager server 324, instructs the storage manager server to discover all available storage on the network. In response, the storage manager issues one or more requests to all known storage arrays to identify all available logical unit numbers (LUNs).

Based on information received from the storage arrays, storage manager server 324 creates and stores information representing of the storage in the system. In one embodiment, storage information is organized in one or more disk wiring map language files. A disk wiring map language is defined herein as a structured markup language that represents disk devices. Information in the wiring map language file represents disk attributes such as disk identifier, size, port, SAN connection, etc. Such information is stored in the control database 322 and is used as a basis for LUN allocation and binding operations.

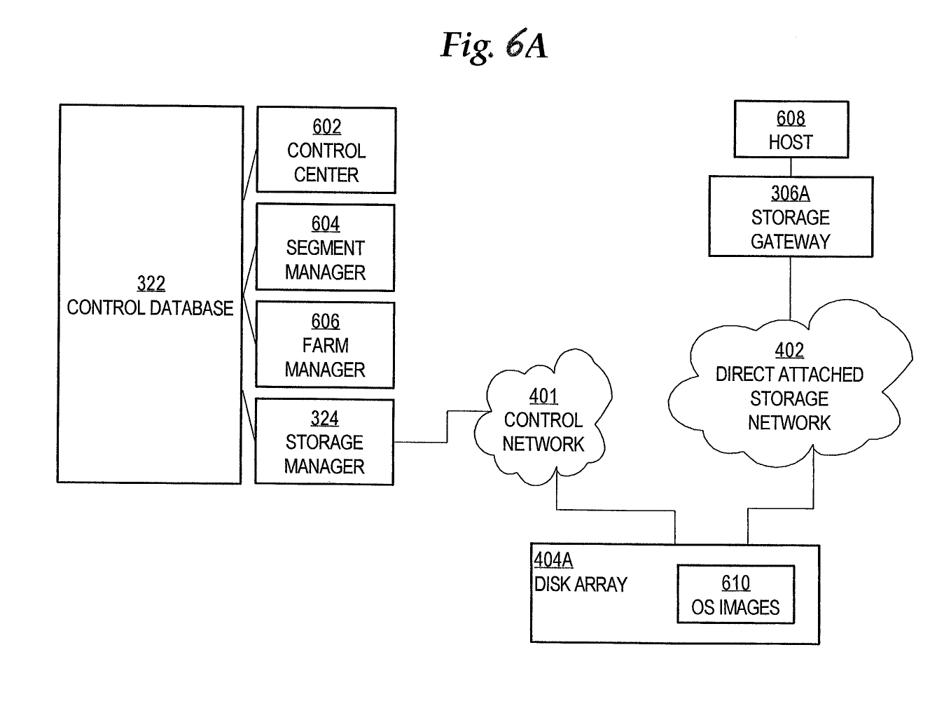

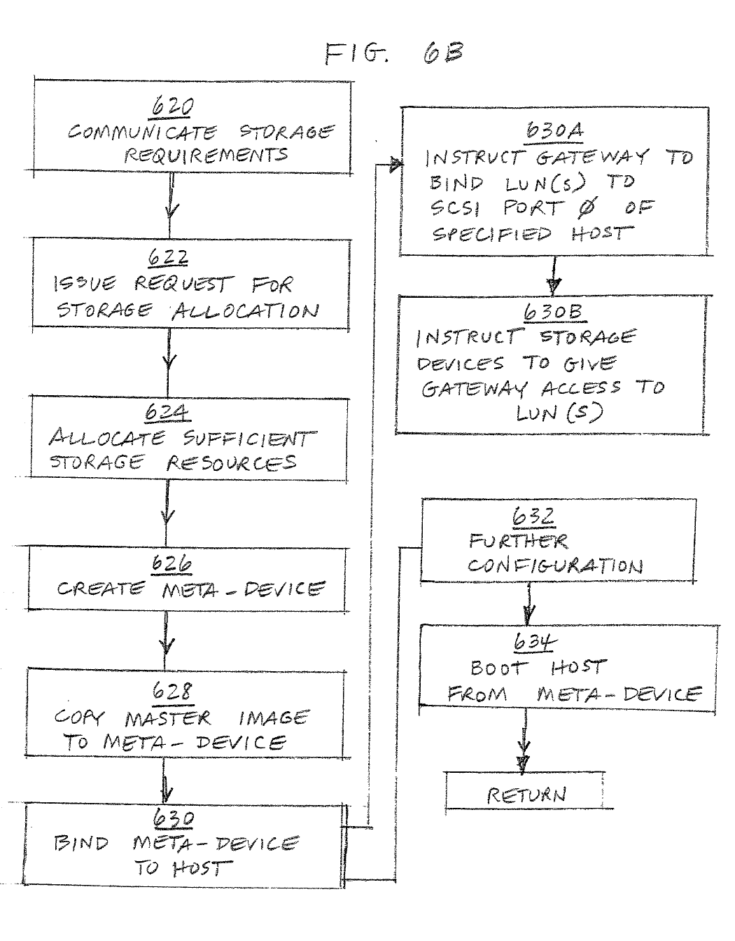

The remaining functions of the API are described herein in the context of FIG. 6A, which is a block diagram of elements involved in creating a binding of a storage unit to a processor.

In the example of FIG. 6A, control database 322 is accessed by a control center or gateway 602, a segment manager 604, a farm manager 606, and storage manager 324. Control center or gateway 602 is one or more application programs that enable an individual to define, deploy, and manage accounting information relating to one or more virtual server farms. For example, using control center 602, a user may invoke a graphical editor to define a virtual server farm visually using graphical icons and connections. A symbolic representation of the virtual server farm is then created and stored. The symbolic representation may comprise a file expressed in a markup language in which disk storage is specified using one or more “disk” tags and “device” tags. Other functions of control center 602 are described in co-pending application Ser. No. 09/863,945, filed May 25, 2001, of Patterson et al.

Segment manager 604 manages a plurality of processors and storage managers that comprise a grid segment processing architecture and cooperate to create, maintain, and deactivate one or more virtual server farms. For example, there may be several hundred processors or hosts in a grid segment. Aspects of segment manager 604 are described in co-pending application Ser. No. 09/630,440, filed Sept. 30, 2000, of Aziz et al. Farm manager 606 manages instantiation, maintenance, and de-activation of a particular virtual server farm. For example, farm manager 606 receives a symbolic description of a virtual server farm from the control center 602, parses and interprets the symbolic description, and allocates, logically and physically connects one or more processors that are needed to implement the virtual server farm. Further, after a particular virtual server farm is created and deployed, additional processors or storage are brought on-line to the virtual storage farm or removed from the virtual storage farm under control of farm manager 606.

Storage manager 324 is communicatively coupled to control network 401, which is communicatively coupled to one or more disk arrays 404A. A plurality of operating system images 610 are stored in association with the disk arrays. Each operating system image comprises a pre-defined combination of an executable operating system, configuration data, and one or more application programs that carry out desired functions, packaged as an image that is loadable to a storage device. For example, there is a generic Windows 2000 image, an image that consists of SunSoft's Solaris, the Apache Web server, and one or more Web applications, etc. Thus, by copying one of the operating system images 610 to an allocated storage unit that is bound to a processor, a virtual server farm acquires the operating software and application software needed to carry out a specified function.

FIG. 6B is a flow diagram of a process of activating and binding a storage unit for a virtual server farm, in one embodiment.

In block 620, storage requirements are communicated. For example, upon creation of a new virtual server farm, control center 602 communicates the storage requirements of the new virtual server farm to segment manager 604.

In block 622, a request for storage allocation is issued. In one embodiment, segment manager 604 dispatches a request for storage allocation to farm manager 606.

Sufficient resources are then allocated, as indicated in block 624. For example, farm manager 606 queries control database 322 to determine what storage resources are available and to allocate sufficient resources from among the disk arrays 404A. In one embodiment, a LUN comprises 9 GB of storage that boots at SCSI port zero. Additional amounts of variable size storage are available for assignment to SCSI ports one through six. Such allocation may involve allocating disk volumes, LUNs or other disk storage blocks that are non-contiguous and not logically organized as a single disk partition. Thus, a process of associating the non-contiguous disk blocks is needed. Accordingly, in one approach, in block 626, a meta-device is created for the allocated storage. In one embodiment, farm manager 606 requests storage manager 324 to create a meta-device that includes all the disk blocks that have been allocated. Storage manager 324 communicates with disk arrays 404A to create the requested meta-device, through one or more commands that are understood by the disk arrays. In another approach, the allocated storage is selected from among one or more volumes of storage that are defined in a database, such as the control database. In yet another feature, the allocated storage is selected from among one or more concatenated volumes that are defined in the database. Alternatively, the storage is allocated “on the fly” by determining what storage is then currently available in one or more storage units. Definition of volumes or concatenated volumes in the database may be carried out by an administrator in advance. In still another approach, all available storage is represented by a storage pool and appropriate size volumes are allocated as needed.

When a meta-device is successfully created, storage manager 324 informs farm manager 606 and provides information identifying the meta-device. In response, a master image of executable software code is copied to the meta-device, as indicated by block 628. For example, farm manager 606 requests storage manager 324 to copy a selected master image from among operating system images 610 to the meta-device. Storage manager 324 issues appropriate commands to cause disk arrays 404A to copy the selected master image from the operating system images 610 to the meta-device.

The meta-device is bound to the host, as shown by block 630. For example, farm manager 606 then requests storage manager 324 to bind the meta-device to a host that is participating in a virtual server farm. Such a processor is represented in FIG. 6A by host 608. Storage manager 324 issues one or more commands that cause an appropriate binding to occur.

In one embodiment the binding process has two sub-steps, illustrated by block 630A and block 630B. In a first sub-step (block 630A), the farm manager 606 calls functions of storage manager client 324C that instruct one of the storage gateways 306A that a specified LUN is bound to a particular port of a specified host. For example, storage manager client 324C may instruct a storage gateway 306A that LUN “17” is bound to SCSI port 0 of a particular host. In one specific embodiment, LUNs are always bound to SCSI port 0 because that port is defined in the operating system of the host as the boot port for the operating system. Thus, after binding LUN “17” to SCSI port 0 of Host A, storage manager client 324C may issue instructions that bind LUN “18” to SCSI port 0 of Host B. Through such a binding, the host can boot from a storage device that is remote and in a central disk array while thinking that the storage device is local at SCSI port 0.

In a second sub-step (block 630B), farm manager 606 uses storage manager client 324C to instruct disk arrays 404A to give storage gateway 306A access to the one or more LUNs that were bound to the host port in the first sub-step. For example, if Host A and Host B are both communicatively coupled to storage gateway 306A, storage manager client 324C instructs disk arrays 404A to give storage gateway 306A access to LUN “17” and LUN “18”.

In one specific embodiment, when a concatenated volume of disk arrays 404A is bound via DAS network 402 to ports that include host 608, a Bind-Rescan command is used to cause storage gateway 306A to acquire the binding to the concatenated volume of storage. Farm manager 606 separately uses one or more Bind-VolumeLogix commands to associate or bind a specified disk concatenated volume with a particular port of a switch in DAS network 402.

The specific sub-steps of block 630A, block 630B are illustrated herein to provide a specific example. However, embodiments are not limited to such sub-steps. Any mechanism for automatically selectively binding designated storage units to a host may be used.

Any needed further configuration is then carried out, as indicated by block 632. For example, farm manager 606 next completes any further required configuration operations relating to any aspect of the virtual server farm that is other construction. Such other configuration may include, triggering a power controller to apply power to the virtual server farm, assigning the host to a load balancer, etc.

The host then boots from the meta-device, as indicated by block 634. For example, host 608 is powered up using a power controller, and boots from its default boot port. In an embodiment, the standard boot port is SCSI port 0. As a result, the host boots from the operating system image that has been copied to the bound concatenated volume of storage.

Referring again to FIG. 5A, device driver 508 is a SCSI device driver that provides the foregoing software elements with low-level, direct access to disk devices. In general, device driver 508 facilitates making image copies from volume to volume. A suitable device driver has been offered by MORE Computer Services, which has information at the “somemore” dot com Web site. In one specific embodiment, the MORE device driver is modified to allow multiple open operations on a device, thereby facilitating one-to-many copy operations. The device driver is further modified to provide end-of-media detection, to simply operations such as volume-to-volume copy.

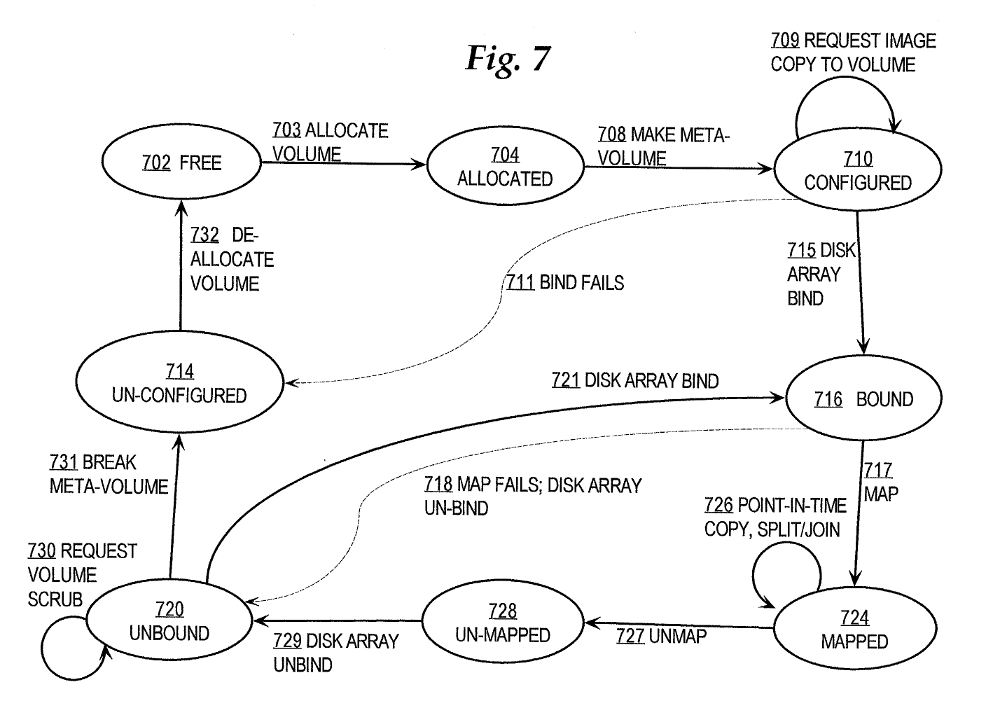

FIG. 7 is a state diagram illustrating states experienced by a disk unit in the course of the foregoing options. In this context, the term “disk unit” refers broadly to a disk block, volume, concatenated, or disk array. In one embodiment, control database 322 stores a state identifier corresponding to the states identified in FIG. 7A for each disk unit. Initially a disk unit is in Free state 702. When a farm manager of a control processor allocates a volume that includes the disk unit, the disk unit enters Allocated state 704. When the farm manager creates a concatenated volume that includes the allocated disk unit, as indicated by Make Meta Volume transition 708, the disk unit enters Configured state 710. The Make Meta Volume transition 708 represents one alternative approach in which concatenated volumes of storage are created “on the fly” from then currently available storage. In another approach, the allocated storage is selected from among one or more volumes of storage that are defined in a database, such as the control database. In yet another feature, the allocated storage is selected from among one or more concatenated volumes that are defined in the database. Definition of volumes or concatenated volumes in the database may be carried out by an administrator in advance. In still another approach, all available storage is represented by a storage pool and appropriate size volumes are allocated as needed.

If the Make Meta Volume transition 708 fails, then the disk unit enters Un-configured state 714, as indicated by Bind Fails transition 711.

When the farm manager issues a request to copy a disk image to a configured volume, as indicated by transition 709, the disk unit remains in Configured state 710. If the disk image copy operation fails, then the disk unit enters Un-configured state 714, using transition 711.

Upon carrying out a Bind transition 715, the disk unit enters Bound state 716. However, if the binding operation fails, as indicated by Bind Fails transition 712, the disk unit enters Un-configured state 714. From Bound state 716, a disk unit normally is mapped to a processor by a storage gateway, as indicated by Map transition 717, and enters Mapped state 724. If the map operation fails, as indicated by Map Fails transition 718, any existing bindings are removed and the disk unit moves to Unbound state 720. The disk unit may then return to Bound state 716 through a disk array bind transition 721, identical in substantive processing to Bind transition 715.

When in Mapped state 724, the disk unit is used in a virtual storage farm. The disk unit may undergo a point-in-time copy operation, a split or join operation, etc., as indicated by Split/join transition 726. Upon completion of such operations, the disk unit remains in Mapped state 724.

When a virtual server farm is terminated or no longer needs the disk unit for storage, it is unmapped from the virtual server farm or its processor(s), as indicated by Unmap transition 727, and enters Unmapped state 728. Bindings to the processor(s) are removed, as indicated by Unbind transition 729, and the disk unit enters Unbound state 720. Data on the disk unit is then removed or scrubbed, as indicated by Scrub transition 730, after which the disk unit remains in Unbound state 720.

When a farm manager issues a command to break a concatenated volume that includes the disk unit, as indicated by Break Meta-Volume transition 731, the disk unit enters Un-configured state 714. The farm manager may then de-allocate the volume, as indicated by transition 732, causing the disk unit to return to the Free state 702 for subsequent re-use.

Accordingly, an automatic process of allocating and binding storage to a virtual server farm has been described. In an embodiment, the disclosed process provides direct storage to virtual server farms in the form of SCSI port targets. The storage may be backed up and may be the subject of destructive or non-destructive restore operations. Arbitrary fibrechannel devices may be mapped to processor SCSI address space. Storage security is provided, as is central management. Direct-attached storage and network-attached storage are supported.

The processes do not depend on any operating system facility and do not interfere with any desired operating system or application configuration or disk image. In particular, although underlying hardware is reconfigured to result in mapping a storage unit or volume to a host, applications and an operating system that are executing at the host are unaware that the host has been bound to a particular data storage unit. Thus, transparent storage resource configuration is provided.

3.4 Database Schema

In one specific embodiment, a disk wiring map identifies one or more devices. A device, for example, is a disk array. For each device, one or more attribute names and values are presented in the file. Examples of attributes include device name, device model, device serial number, etc. A disk wiring map also identifies the names and identifiers of ports that are on the control network 401.

Also in one specific embodiment, each definition of a device includes one or more definitions of volumes associated with the device. Each disk volume definition comprises an identifier or name, a size value, and a type value. One or more pairs of disk volume attributes and their values may be provided. Examples of disk volume attributes include status, configuration type, spindle identifiers, etc. The disk volume definition also identifies ports of the volume that are on a control network, and the number of logical units in the disk volume.

FIG. 5B is a block diagram illustrating elements of a control database.

In one embodiment, control database 322 comprises a Disk Table 510, Fiber Attach Port Table 512, Disk Fiber Attach Port Table 514, and Disk Binding Table 516. The Disk Table 510 comprises information about individual disk volumes in a disk array. A disk array is represented as one physical device. In one specific embodiment, Disk Table 510 comprises the information shown in Table 1.

TABLE 1
DISK TABLE

| Column Name | Type | Description |
|---|---|---|
| Disk ID | Integer | Disk serial number |
| Disk Array | Integer | Disk array device identifier |
| Disk Volume ID | String | Disk volume identifier |
| Disk Type | String | Disk volume type |
| Disk Size | Integer | Disk volume size in MB |
| Disk Parent | Integer | Parent disk ID, if the associated disk is part |
| | | of a concatenated disk set making up a larger |
| | | volume |
| Disk Order | Integer | Serial position in the concatenated disk set |
| Disk BCV | Integer | Backup Control Volume ID for the disk |
| Disk Farm ID | String | Farm ID to which this disk is assigned |
| | | currently |
| Disk Time Stamp | Date | Last update time stamp for the current record |
| Disk Status | String | Disk status (e.g., FREE, ALLOCATED, |
| | | etc.) among the states of FIG. 7 |
| Disk Image ID | Integer | Software image ID for any image on the disk |

Fiber Attach Port Table 512 describes fiber-attach (FA) port information for each of the disk arrays. In one specific embodiment, Fiber Attach Port Table 512 comprises the information set forth in Table 2.

TABLE 2
DISK TABLE

| Column Name | Type | Description |
|---|---|---|
| FAP ID | Integer | Fiber Attached Port identifier; a unique |
| | | integer that is internally assigned |
| FAP Disk Array | Integer | Identifier of the storage array to which the |
| | | FAP belongs. |
| FA Port ID | String | Device-specific FAP identifier. |
| FA Worldwide | String | Worldwide Name of the fiber attached port. |
| Name | | |
| FAP SAN | String | Name of the storage area network to which |
| | | the FAP is attached. |
| FAP Type | String | FAP type, e.g., back-end or front-end. |
| FAP Ref Count | Integer | FAP reference count; identifies the number |
| | | of CPUs that are using this port to connect to |
| | | disk volumes. |

Disk Fiber Attach Port Table 514 describes mappings of an FA Port to a LUN for each disk, and may comprise the information identified in Table 3.

TABLE 3
DISK FIBER ATTACH TABLE

| Column | | |
|---|---|---|
| Name | Type | Description |
| Disk ID | Integer | Disk volume identifier; refers to an entry in Disk |
| | | Table 510. |
| FAP | Integer | Fiber-attach port identifier; refers to an entry in |
| Identifier | | Fiber Attach Port Table 512. |
| LUN | String | Disk logical unit name on this fiber-attach port. |

In one embodiment, Disk Binding Table 516 is a dynamic table that describes the relation between a disk and the host that has access to it. In one specific embodiment, Disk Binding Table 516 holds the information identified in Table 4.

TABLE 4
DISK BINDTNG TABLE

| Column | | |
|---|---|---|
| Name | Type | Description |
| Disk ID | Integer | Disk volume identifier; refers to an entry in Disk |
| | | Table 510. |
| Port ID | Integer | FAP identifier; refers to an entry in the Fiber Attach |
| | | Port table at which this disk will be accessed. |
| Host ID | Integer | A device identifier of the CPU that is accessing the |
| | | disk. |
| Target | Integer | The SCSI target identifier at which the CPU |
| | | accesses the disk. |
| LUN | Integer | The SCSI LUN identifier at which the CPU accesses |
| | | the disk. |

3.5 Software Architecture

FIG. 8 is a block diagram of software components that may be used in an example implementation a storage manager and related interfaces.

A Farm Manager Wired class 802, which forms a part of farm manager 326, is the primary client of the storage services that are represented by other elements of FIG. 8. Farm Manager Wired class 802 can call functions of SAN Fabric interface 804, which defines the available storage-related services and provides an application programming interface. Functions of SAN Fabric interface 804 are implemented in SAN Fabric implementation 806, which is closely coupled to the interface 804.

SAN Fabric implementation is communicatively coupled to and can call functions of a SAN Gateway interface 808, which defines services that are available from storage gateways 306. Such services are implemented in SAN Gateway implementation 810, which is closely coupled to SAN Gateway interface 808.

A Storage Manager Services layer 812 defines the services that are implemented by the storage manager, and its functions may be called both by the storage manager client 324C and storage manager server 324 in storage manager server machine 324A. In one specific embodiment, client-side storage management services of storage manager client 324C are implemented by Storage Manager Connection 814.

The Storage Manager Connection 814 sends requests for services to a request queue 816. The Storage Manager Connection 814 is communicatively coupled to Storage Manager Request Handler 818, which de-queues requests from the Storage Manager Connection and dispatches the requests to a Request Processor 820. Request Processor 820 accepts storage services requests and runs them. In a specific embodiment, request queue 816 is implemented using a highly-available database for storage of requests. Queue entries are defined to include Java® objects and other complex data structures.

In one embodiment, Request Processor 820 is a class that communicates with service routines that are implemented as independent Java® or Perl programs, as indicated by Storage Integration Layer Programs 822. For example, Storage Integration Layer Programs 822 provide device access control, a point-in-time copy function, meta-device management, and other management functions. In one specific embodiment, in which the disk arrays are products of EMC, access control is provided by the VolumeLogix program of EMC; point-in-time copy functions are provided by TimeFinder; meta-device management is provided by the EMC Symmetrix Configuration Manager (“symconfig”); and other management is provided by the EMC Control Center.

A Storage Manager class 824 is responsible for startup, configuration, and other functions.

SAN Gateway implementation 810 maintains data structures in memory for the purpose of organizing information mappings useful in associating storage with processors. In one specific embodiment, SAN Gateway implementation 810 maintains a Virtual Private Map that associates logical unit numbers or other storage targets to SCSI attached hosts. SAN Gateway implementation 810 also maintains a Persistent Device Map that associates disk devices with type information, channel information, target identifiers, LUN information, and unit identifiers, thereby providing a basic map of devices available in the system. SAN Gateway implementation 810 also maintains a SCSI Map that associates SCSI channel values with target identifiers, LUN identifiers, and device identifiers, thereby showing which target disk unit is then-currently mapped to which SCSI channel.

Referring again to FIG. 8, a plurality of utility methods or sub-routines are provided including Disk Copy utility 832, Disk Allocate utility 834, Disk Bind utility 836, Disk Configure utility 838, and SAN Gateway utility 840.

Disk Copy utility 832 is used to copy one unbound volume to another unbound volume. Disk Allocate utility 834 is used to manually allocate a volume; for example, it may be used to allocate master volumes that are not associated with a virtual server farm. Disk Bind utility 836 is used to manually bind a volume to a host. Disk Configure method 838 is used to manually form or break a concatenated. SAN Gateway utility 840 enables direct manual control of a SAN gateway 306.

3.6 Global Namespace for Volumes

The foregoing arrangement supports a global namespace for disk volumes. In this arrangement, different processors can read and write data from and to the same disk volume at the block level. As a result, different hosts of a virtual server farm can access shared content at the file level or the block level. There are many applications that can benefit from the ability to have simultaneous access to the same block storage device. Examples include clustering database applications, clustering file systems, etc.

An application of Aziz et al. referenced that discloses symbolic definition of virtual server farms using a farm markup language in which storage is specified using <disk /disk> tags. However, in that disclosure, the disk tags all specify block storage disks that are specific to a given server. There is a need to indicate that a given disk element described via the <disk/disk> tags in the markup language should be shared between a set of servers in a particular virtual server farm.

In one approach, the farm markup language includes a mechanism to indicate to the Grid Control Plane that a set of LUNs are to be shared between a set of servers. In a first aspect of this approach, as shown in the code example of Table 5, a virtual server farm defines a set of LUNs that are named in farm global fashion; rather than using disk tags to name disks on a per server basis.

TABLE 5
FML DEFINITION OF LUNS THAT ARE
GLOBAL TO A FARM

<farm fmlversion=“1.2”>
<farm-global-disks>

<global-disk global-name=“Oracle Cluster, partition 1”,
drivesize=“8631”>
<global-disk global-name=“Oracle Cluster, partition 2”,
drivesize=“8631”>

</farm-global-disks>

..
</farm>

In another aspect of this approach, as shown in the code example of Table 5, the markup language is used to specify a way to reference farm-global-disks from a given server, and indicate how to map that global disk to disks that are locally visible to a given server, using the <shared-disk> tag described below.

TABLE 5
FML DEFINITION OF LUNS THAT ARE
GLOBAL TO A FARM

<server-role id=“role37” name=“Server1”>

<hw>cpu-sun4u-x4</hw>

<disk target=“0” drivetype=“scsi” drivesize=“8631”>

<diskimage type=“system”>solaris</diskimage>
<attribute name=“backup-policy” value=“nightly” />

</disk>

<shared-disk global-name=“Oracle Cluster, partition 1”,
target=“1” drivetype=“scsi” /shared-disk>
<shared-disk global-name=“Oracle Cluster, partition 2”,
target=“2” drivetype=“scsi” /shared-disk>

</server-role>

In the example given above, the server-role definition shows a server that has a local-only disk, specified by the <disk> tag, and two disks that can be shared by other servers specified by the <shared-disk> tags. As long as the global-name of the shared disks are the same as the global-name of one of the global disks identified in the <farm-global-disks> list, then it is mapped to the local drive target as indicated in the <shared-disk> elements.

To instantiate a virtual server farm with this approach, the storage management subsystem of the grid control plane first allocates all the farm-global-disks prior to any other disk processing. Once these disks have been created and allocated, using the processes described in this document, the storage management subsystem processes all the shared-disk elements in each server definition. Whenever a shared-disk element refers to a globally visible disk, it is mapped to the appropriate target, as specified by the local-target tag. Different servers then may view the same piece of block level storage as the same or different local target numbers.

By specifying different drive types, e.g., fibre-channel or iSCSI, different storage access mechanisms can be used to access the same piece of block level storage. In the example above, “scsi” identifies a local SCSI bus as a storage access mechanism. This local SCSI bus is attached to the virtual storage layer described herein.

4.0 Hardware Overview

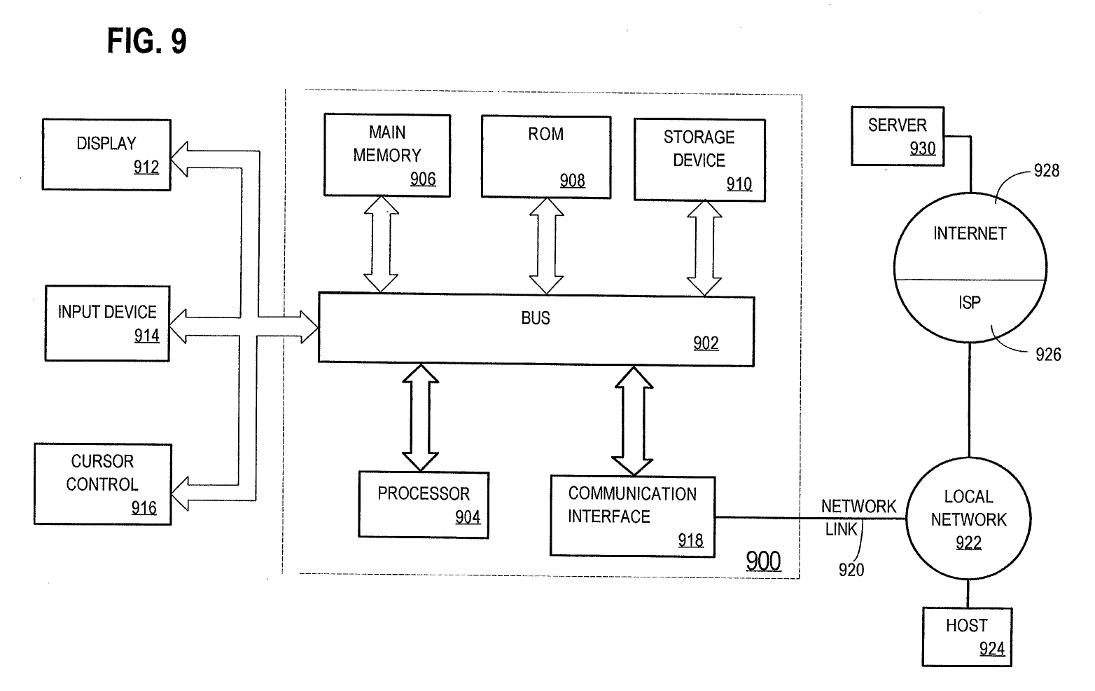

FIG. 9 is a block diagram that illustrates a computer system 900 upon which an embodiment of the invention may be implemented.

Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device may have two degrees of freedom in a first axis (e.g., x) and a second axis (e.g., y), that allows the device to specify positions in a plane.

The invention is related to the use of computer system 900 for symbolic definition of a computer system. According to one embodiment of the invention, symbolic definition of a computer system is provided by computer system 900 in response to processor 904 executing one or more sequences of one or more instructions contained in main memory 906. Such instructions may be read into main memory 906 from another computer-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infrared transmitter to convert the data to an infrared signal. An infrared detector can receive the data carried in the infrared signal and appropriate circuitry can place the data on bus 902. Bus 902 carries the data to main memory 906, from which processor 904 retrieves and executes the instructions. The instructions received by main memory 906 may be stored on storage device 910.

Computer system 900 also includes a communication interface 918 coupled to bus 902. Communication interface 918 provides a two-way data communication coupling to a network link 920 that is connected to a local network 922. For example, communication interface 918 is an ISDN card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918 are example forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. In accordance with the invention, one such downloaded application provides for symbolic definition of a computer system as described herein. Processor 904 may executed received code as it is received, or stored in storage device 910, or other non-volatile storage for later execution. In this manner, computer system 900 may obtain application code in the form of a carrier wave.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of selectively allocating storage to a processor comprising the computer-implemented steps of:
receiving a request to allocate storage to the processor; and
configuring a virtual storage layer to logically associate one or more logical units from among one or more storage units to the processor.

2. A method as recited in claim 1, wherein the configuring step is carried out without modification to an operating system of the processor.

3. A method as recited in claim 1, wherein the configuring step is carried out by a control processor that is coupled through one or more storage networks to a plurality of storage gateways that are coupled through the storage networks to the one or more storage units.

4. A method as recited in claim 1, wherein the configuring step further comprises the steps of:
configuring a storage gateway in the virtual storage layer to map the logical units to a boot port of the processor; and
configuring the one or more storage units to give the processor access to the logical units.

5. A method as recited in claim 1, wherein the virtual storage layer comprises a control processor that is coupled through a storage network to a storage gateway, wherein the storage gateway is coupled through the storage network to the one or more storage units, and wherein the configuring step further comprises the steps of:
the control processor issuing instructions to the storage gateway to map the logical units to a boot port of the processor; and
the control processor issuing instructions to the storage units to give the processor access to the one or more logical units.

6. A method as recited in claim 1, wherein the configuring step further comprises the steps of:
receiving the request to allocate storage at a control processor that is coupled through a storage network to a storage gateway, wherein the storage gateway is coupled through the storage networks to the one or more storage units;
instructing the storage gateway to map the one or more logical units to a boot port of the processor; and
instructing the one or more storage units to give the processor access to the one or more logical units.

7. A method as recited in claim 1, wherein:
the method further comprises the step of storing first information that associates processors to logical units, and second information that associates logical units to storage units, and
the configuring step further comprises the step of mapping the one or more logical units from among the one or more storage units to a boot port of the processor by reconfiguring the virtual storage layer to logically couple the one or more logical units to the boot port based on the stored first information and second information.

8. A method as recited in claim 1,
further comprising the step of generating the request to allocate storage at a control processor that is communicatively coupled to a control database, wherein the request is directed from the control processor to a storage manager that is communicatively coupled to the control processor, the control database, and a storage network that includes a disk gateway, and
wherein the step of configuring the virtual storage layer includes reconfiguring the disk gateway to logically couple the one or more logical units to a boot port of the processor.

9. A method as recited in claim 8, further comprising the step of issuing instructions from the storage manager to the one or more storage units to give the processor access to the one or more logical units.

10. A method as recited in claim 1, wherein the configuring step further comprises the steps of:
identifying one or more logical units (LUNs) of the one or more storage units that have a sufficient amount of storage to satisfy the request;
instructing a storage gateway in the virtual storage layer to map the identified LUNs to the small computer system interface (SCSI) port zero of the processor based on a unique processor identifier; and
instructing the one or more storage units to give the processor having the unique host identifier access to the identified LUNs.

11. A method as recited in claim 1, wherein the configuring step comprises:
issuing a request to allocate one or more volumes on one of the one or more storage units;
issuing a request to make a concatenated volume using the one or more allocated volumes;
configuring the concatenated volume for use with the processor;
issuing first instructions to the one or more storage units to bind the processor to the concatenated volume by giving the processor access to the concatenated volume;
issuing second instructions to a gateway in the virtual storage layer to bind the concatenated volume to the processor.

12. A method as recited in claim 11, further comprising the steps of:
determining that the second instructions have failed to bind the concatenated volume to the processor;
issuing third instructions to the one or more storage units to un-bind the processor from the concatenated volume.

13. A method as recited in claim 11, further comprising the steps of:
determining that the first instructions have failed to bind the processor to the concatenated volume;
issuing fourth instructions to the one or more storage units to break the concatenated volume.

14. A method as recited in claim 1, wherein the one or more logical units associated with the processor include at least one logical unit from a first volume from the one or more storage units, and at least one logical unit from a second volume from among the one or more storage units.

15. A method as recited in claim 1, wherein the request to allocate storage specifies an amount of storage to be allocated.

16. A method as recited in claim 1, wherein the request to allocate storage specifies a type of storage to be allocated.

17. A method of selectively associating storage with a host processor without modification to an operating system of the host, comprising the steps of:
receiving a request to associate the storage at a virtual storage layer that is coupled to a plurality of storage units and to one or more host processors, wherein the request identifies a particular host processor and an amount of requested storage;
configuring the virtual storage layer to logically couple one or more logical units from among the plurality of storage units having the requested amount of storage to a standard boot port of the particular host processor, by instructing a storage gateway in the virtual storage layer to map the one or more logical units to the standard boot port of the particular host processor, and instructing the plurality of storage units to give the particular host processor access to the one or more logical units.

18. A method as recited in claim 17, wherein the configuring step comprises:
issuing a request to allocate one or more volumes on one of the plurality of storage units having the requested amount of storage;
issuing a request to make a concatenated volume using the one or more allocated volumes;
configuring the concatenated volume for use with the particular host processor;
issuing first instructions to the plurality of storage units to bind the particular host processor to the concatenated volume by giving the particular host processor access to the concatenated volume;
issuing second instructions to a gateway in the virtual storage layer to bind the concatenated volume to the particular host processor.

19. A method as recited in claim 18, further comprising the steps of:
determining that the second instructions have failed to bind the concatenated volume to the particular host processor;
issuing third instructions to the plurality of storage units to un-bind the particular host processor from the concatenated volume.

20. A method as recited in claim 18, further comprising the steps of:
determining that the first instructions have failed to bind the particular host processor to the concatenated volume;
issuing fourth instructions to the plurality of storage units to break the concatenated volume.

21. A method of selectively associating storage with a host processor, comprising the steps of:
receiving, at a virtual storage layer that is coupled to a plurality of storage units and to one or more host processors, a request to associate the storage, wherein the request identifies the host processor and an amount of storage to be associated with the host processor;
mapping one or more sub-units of storage from among the plurality of storage units to a standard boot port of the host processor by logically coupling the one or more sub-units to the standard boot port of the host processor by instructing a gateway to couple the host processor to the one or more sub-units and by instructing the plurality of storage units.

22. A computer-readable medium carrying one or more sequences of instructions for selectively associating storage with a host processor in a networked computer system, wherein execution of the one or more sequences of instructions by one or more processors causes the one or more processors to perform the steps of:
receiving a request to associate the storage at a virtual storage layer that is coupled to a plurality of storage units and to one or more host processors that have no then-currently assigned storage, wherein the request identifies a particular host and an amount of requested storage;
mapping one or more logical units from among the storage units having the requested amount of storage to a standard boot port of the identified host, by reconfiguring the virtual storage layer to logically couple the logical units to the boot port.

23. An apparatus for defining and deploying a networked computer system, comprising:
means for receiving a request at a virtual storage layer that is coupled to a plurality of storage units to associate storage with a particular host processor, wherein the request specifies an amount of requested storage;
means for mapping one or more logical units from among the plurality of storage units having the amount of requested storage to a standard boot port of the particular host processor by reconfiguring the virtual storage layer to logically couple the one or more logical units to the standard boot port of the particular host processor.

24. An apparatus for defining and deploying a networked computer system, comprising:
a processor;
a computer-readable medium accessible to the processor and storing a textual representation of a logical configuration of the networked computer system according to a structured markup language;
one or more sequences of instructions stored in the computer-readable medium and which, when executed by the processor, cause the processor to carry out the steps of:
receiving a request to associate storage, wherein the request is received at a virtual storage layer that is coupled to a plurality of storage units to a particular host processor, wherein the request specifies an amount of requested storage;
mapping one or more logical units from among the plurality of storage units having the requested amount of storage to a standard boot port of the particular host processor by reconfiguring the virtual storage layer to logically couple the one or more logical units to the boot port of the particular host processor.

25. A system for selectively associating storage with a host processor, comprising:
a virtual storage mechanism that is coupled to a plurality of storage units and to one or more host processors;
a control processor that is communicatively coupled to the virtual storage mechanism and that comprises a computer-readable medium carrying one or more sequences of instructions which, when executed by one or more processors, cause the one or more processors to carry out the steps of:
receiving a request to associate storage with a particular host processor, wherein the request identifies an amount of requested storage;
mapping one or more logical units from among the storage units having the requested amount of storage to a standard boot port of the particular host processor, by reconfiguring the virtual storage mechanism to logically couple the one or more logical units to the standard boot port of the particular host processor.

26. A system as recited in claim 25, wherein the control processor is coupled through one or more storage networks to a plurality of storage gateways that are coupled through the one or more storage networks to the plurality of storage units.

27. A system as recited in claim 25,
wherein the control processor is coupled through a storage network to a storage gateway that is coupled through the storage networks to the plurality of storage units, and
wherein the sequences of instructions of the control processor further comprise instructions which, when executed by the one or more processors, cause the one or more processors to carry out the steps of:
issuing instructions from the control processor to the storage gateway to map the one or more logical units to the standard boot port of the particular host processor; and
issuing instructions from the control processor to the plurality of storage units to give the particular host processor access to the one or more logical units.

28. A system as recited in claim 25,
wherein the control processor is communicatively coupled to a control database that comprises first information that associates hosts to logical units, and second information that associates logical units to storage units; and
wherein the sequences of instructions of the control processor further comprise instructions which, when executed by the one or more processors, cause the one or more processors to carry out the steps of mapping one or more logical units from among the plurality of storage units having the requested amount of storage to the standard boot port of the particular host processor by reconfiguring the virtual storage mechanism to logically couple the one or more logical units to the standard boot port of the particular host processor based on the first information and the second information.

29. A system as recited in claim 25, wherein the sequences of instructions of the control processor further comprise instructions which, when executed by the one or more processors, cause the one or more processors to carry out the steps of:
identifying one or more logical units (LUNs) of the plurality of storage units that have the requested amount of storage;
instructing a storage gateway in the virtual storage layer to map the identified LUNs to the small computer system interface (SCSI) port zero of the particular host processor based on a unique host identifier; and
instructing the plurality of storage units to give the particular host processor having the unique host identifier access to the identified LUNs.

30. A system as recited in claim 25, wherein the sequences of instructions of the control processor further comprise instructions which, when executed by the one or more processors, cause the one or more processors to carry out the steps of:
issuing a request to allocate one or more volumes on one of the plurality of storage units having the requested amount of storage;
issuing a request to make a concatenated volume using the one or more allocated volumes;
configuring the concatenated volume for use with the particular host processor;
issuing first instructions to the plurality of storage units to bind the particular host processor to the concatenated volume by giving the particular host processor access to the concatenated volume;
issuing second instructions to a gateway in the virtual storage layer to bind the concatenated volume to the particular host processor.

31. A system as recited in claim 25, wherein the sequences of instructions of the control processor further comprise instructions which, when executed by the one or more processors, cause the one or more processors to carry out the steps of:
determining that the second instructions have failed to bind the concatenated volume to the particular host processor;
issuing third instructions to the plurality of storage units to un-bind the particular host processor from the concatenated volume.

32. A system as recited in claim 25, wherein the sequences of instructions of the control processor further comprise instructions which, when executed by the one or more processors, cause the one or more processors to carry out the steps of
determining that the first instructions have failed to bind the particular host processor to the concatenated volume;
issuing fourth instructions to the plurality of storage units to break the concatenated volume.

33. A method of selectively allocating storage to a processor comprising the computer-implemented steps of:
receiving a request to allocate storage to the processor; and
logically assigning one or more logical units from among one or more storage units to the processor, wherein the one or more logical units include at least one logical unit from a first volume from the one or more storage units and at least one logical unit from a second volume from the one or more storage units.

34. A method as recited in claim 1, wherein the configuring step is carried out by a switch device in a storage area network.

35. A method as recited in claim 1, wherein the configuring step is carried out by a disk array in a storage area network.

36. A method as recited in claim 1, wherein the one or more logical units associated with the processor include at least one logical unit comprising a first volume of storage of a first storage unit and a second volume of storage from a second storage unit.

37. A method of selectively allocating storage to a processor comprising the computer-implemented steps of:
receiving a symbolic definition of a virtual server farm that includes a storage definition;
based on the storage definition, creating a request to allocate storage to the processor; and
configuring a virtual storage layer to logically associate one or more logical units from among one or more storage units to the processor.

38. A method as recited in claim 37, wherein the storage definition identifies an amount of requested storage and a SCSI target for the storage.

39. A method as recited in claim 37, wherein the storage definition identifies an amount of requested storage and a file system mount point for the storage.
